(19) United States
(12) Patent Application Publication
(10) Pub. No.: US 2025/0155834 A1
(43) Pub. Date: May 15, 2025

(54) GREEN TONER FOR ELECTROSTATIC CHARGE IMAGE DEVELOPMENT, ELECTROSTATIC CHARGE IMAGE DEVELOPER, TONER CARTRIDGE, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Tomoaki TANAKA, Kanagawa (JP); Kotaro YOSHIHARA, Kanagawa (JP); Asafumi FUJITA, Kanagawa (JP); Tsuyoshi MURAKAMI, Kanagawa (JP)

(73) Assignee: FUJIFILM Business Innovation Corp., Tokyo (JP)

(21) Appl. No.: 18/731,759

(22) Filed: Jun. 3, 2024

(30) Foreign Application Priority Data
Nov. 14, 2023 (JP) 2023-193888

(51) Int. Cl. G03G 9/097; G03G 9/08; G03G 9/087; G03G 9/09

(52) U.S. Cl. CPC G03G 9/09725; G03G 9/0819; G03G 9/08755; G03G 9/0922

(57) ABSTRACT

A green toner for electrostatic charge image development includes green toner particles containing a binder resin, an azomethine fluorescent pigment having an emission peak in a wavelength region of 500 nm or more and 550 nm or less in an emission spectrum, and a non-fluorescent pigment having a reflection peak in a wavelength region of 480 nm or more and 540 nm or less in a reflection spectrum. A mass proportion of the azomethine fluorescent pigment in the green toner particles is 3% by mass or more and 20% by mass or less; and silica particles externally added to the green toner particles. The silica particles have an average primary particle size of 50 nm or more and 350 nm or less.

### CROSS-REFERENCE TO RELATED APPLICATIONS

This application is based on and claims priority under 35 USC 119 from Japanese Patent Application No. 2023-193888 filed Nov. 14, 2023.

### BACKGROUND

### (i) Technical Field

The present disclosure relates to a green toner for electrostatic charge image development, an electrostatic charge image developer, a toner cartridge, a process cartridge, an image forming apparatus, and an image forming method.

### (ii) Related Art

Japanese Unexamined Patent Application Publication No. 2012-189989 discloses a green toner for electrostatic charge image development containing C.I. Solvent Green 5 and a phthalocyanine-based colorant compound X, in which the content of C.I. Solvent Green 5 in the total amount of colorants is 5% by mass or more and 50% by mass or less.

Japanese Unexamined Patent Application Publication No. 2016-017135 discloses a colorant composition containing a copper phthalocyanine pigment, a fluorescent dye, and a resin binder, in which the hue angle of a coated product of the composition on white paper is 236° or less and the fluorescent dye enables the visible reflection spectrum of a coating film that is formed of the fluorescent dye and the resin binder but does not contain the copper phthalocyanine pigment to have a maximum reflectance of 90% to 130%.

Japanese Unexamined Patent Application Publication No. 2011-128414 discloses a toner for electrostatic charge image development containing a yellow-based non-fluorescent dye of which the peak wavelength in the absorption spectrum is in a wavelength region of 400 to 480 nm and a fluorescent dye of which the peak wavelength in the emission spectrum is in a wavelength region of 480 to 560 nm, in which the content of the non-fluorescent dye is 2 to 8 parts by mass with respect to 100 parts by mass of the binder resin, the content of the fluorescent dye is 0.05 to 0.2 parts by mass with respect to 100 parts by mass of the binder resin, and the content ratio represented by an expression (content of non-fluorescent dye/content of fluorescent dye) is in a range of 15 to 150.

Japanese Unexamined Patent Application Publication No. 2017-003818 discloses a toner that satisfies W_{G}×0.5>W_{F}>W_{G}×0.025, where W_{G} and W_{F} denote the mass-based content of a coloring pigment and the mass-based content of a fluorescent dye, respectively, and satisfies P_{G}<P_{F}, where P_{G} denotes the absorption peak wavelength of the coloring pigment and P_{F} denotes the emission peak wavelength of the fluorescent dye.

Japanese Unexamined Patent Application Publication No. 2019-132993 discloses a toner that includes toner particles containing toner base particles containing a fluorescent pigment and a binder, and containing an external additive fixed to surfaces of the toner base particles, in which the content of the fluorescent pigment in the toner base particles is 0.3% by weight or more and 3.0% by weight or less, and the ratio of a number-based particle size distribution to a volume-based particle size distribution of the toner particles is 0.66 or more and 1.00 or less.

### SUMMARY

An image display section of an electronic device is generally in a so-called RGB color mode in which a color is expressed by a combination of three colors of red (R), green (G), and blue (B).

Meanwhile, electrophotographic image formation is generally performed in a so-called CMYK color mode in which a color is expressed by a combination of four colors of cyan (C), magenta (M), yellow (Y), and black (K).

When an image expressed in the RGB color mode is reproduced on a recording medium in the CMYK color mode, a secondary color such as green, pink, or orange tends to become dull.

A green toner, a pink toner, or an orange toner has been developed for the purpose of enhancing color reproducibility of green, pink, or orange in electrophotographic image formation. As the green toner, a toner containing a yellow fluorescent dye (for example, C.I. Solvent Green 5) and a green pigment or a blue pigment is known.

However, since a fluorescent dye generally causes concentration quenching in which light emission is attenuated as the concentration increases, it is difficult to reproduce a color having higher brightness and higher chroma with a green toner containing a fluorescent dye.

For the purpose of achieving reproduction of a color having high brightness and high chroma, development of a green toner in which a fluorescent dye is replaced with a fluorescent pigment has been advanced.

However, since pigments have a larger specific gravity than dyes, the specific gravity of the green toner increases when the fluorescent dye is replaced with the fluorescent pigment. The green toner is also used less frequently than toners of CMYK colors and stays in the developing device for a longer time (that is, the toner is stirred for a longer time). Therefore, the green toner is likely to aggregate with each other by stirring in the developing device, and color spots are likely to be formed in an image.

The present disclosure has been made in view of the above circumstances.

Aspects of non-limiting embodiments of the present disclosure relate to a green toner for electrostatic charge image development in which color spots are less likely to be formed in an image as compared with a green toner for electrostatic charge image development in which silica particles serving as an external additive have an average primary particle size of less than 50 nm.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a green toner for electrostatic charge image development including green toner particles containing a binder resin, an azomethine fluorescent pigment having an emission peak in a wavelength region of 500 nm or more and 550 nm or less in an emission spectrum, and a non-fluorescent pigment having a reflection peak in a wavelength region of 480 nm or more and 540 nm or less in a reflection spectrum, where a mass proportion of the azomethine fluorescent pigment in the green toner particles is 3% by mass or more and 20% by mass or less; and silica particles externally added to the green toner particles, wherein the silica particles have an average primary particle size of 50 nm or more and 350 nm or less.

### BRIEF DESCRIPTION OF THE DRAWINGS

Exemplary embodiments of the present disclosure will be described in detail based on the following figures, wherein:

FIG. 1 is a schematic configuration diagram illustrating an example of an image forming apparatus according to the present exemplary embodiment; and

FIG. 2 is a schematic configuration diagram illustrating an example of a process cartridge to be detachably attached to an image forming apparatus according to the present exemplary embodiment.

### DETAILED DESCRIPTION

Hereinafter, exemplary embodiments of the present disclosure will be described. The description of these and Examples are illustrative of exemplary embodiments and are not intended to limit the scope of the exemplary embodiments.

In the present disclosure, “A and/or B” is synonymous with “at least one of A and B”. In other words, it means that “A and/or B” may be A, may be B, or may be a combination of A and B.

In the present disclosure, a numerical range indicated by using “to” indicates a range including the numerical values before and after “to” as the minimum and maximum values, respectively.

In the numerical ranges described stepwise in the present disclosure, the upper limit value or lower limit value described in one numerical range may be replaced with the upper limit value or lower limit value of another numerical range described stepwise. In a numerical range described in the present disclosure, the upper limit value or lower limit value in the numerical range may be replaced with a value presented in Examples.

In the present disclosure, the term “step” includes not only an independent step but also a step that cannot be clearly distinguished from another step as long as the purpose of the step is achieved.

When an exemplary embodiment of the present disclosure is described with reference to the drawings, the configuration of the exemplary embodiment is not limited to the configuration illustrated in the drawings. The sizes of the members in the respective drawings are conceptual, and the relative relation in size between the members is not limited thereto.

In the present disclosure, each component may contain a plurality of kinds of corresponding substances. In the present disclosure, when referring to the amount of each component in a composition, in a case where a plurality of kinds of substances corresponding to each component are present in the composition, the amount means the total amount of the plurality of kinds of substances present in the composition unless otherwise stated.

In the present disclosure, particles corresponding to each component may include a plurality of kinds. In a case where a plurality of kinds of particles corresponding to each component are present in a composition, the particle size of each component means a value for a mixture of the plurality of kinds of particles present in the composition unless otherwise stated.

In the present disclosure, when a compound is represented by a structural formula, the compound may be represented by a structural formula in which symbols (C and H) representing a carbon atom and a hydrogen atom in a hydrocarbon group and/or a hydrocarbon chain are omitted.

In the present disclosure, the term “(meth)acryl” is an expression that includes both acryl and methacryl, and the term “(meth)acrylate” is an expression that includes both acrylate and methacrylate.

In the present disclosure, the “toner for electrostatic charge image development” is also referred to as “toner”, the “green toner for electrostatic charge image development” is also referred to as “green toner”, the “electrostatic charge image developer” is also referred to as “developer”, and the “carrier for electrostatic charge image development” is also referred to as “carrier”.

In the present disclosure, the Colour Index is abbreviated as “C.I.”

### <Green Toner for Electrostatic Charge Image Development>

In the present disclosure, the green toner means a toner in which the hue angle h of a solid image (an image having a density of 100%) formed on coated paper is 128.5° or more and 144.5° or less. The hue angle h is an angle calculated from a* and b* values in the CIE1976 L*a*b* color space by the following equation.

Hue angle h=tan⁻¹(b*/a*)

In the present disclosure, the hue angle h of the solid image formed on the coated paper using the green toner is preferably 131° or more and 143° or less, more preferably 135° or more and 140° or less.

In the present disclosure, a solid image (an image having a density of 100%) formed on coated paper using the green toner preferably has a brightness L* of 70 or more and a chroma C* of 85 or more in the CIE1976 L*a*b* color space. The chroma C* is a value calculated from a* and b* values in the CIE1976 L*a*b* color space by the following equation.

Chroma C*={(a*)²+(b*)²}^{0.5}

In the present disclosure, the fluorescent pigment refers to a pigment that emits light by light energy from the outside, and the non-fluorescent pigment refers to a pigment that does not emit light by light energy from the outside. In general, a fluorescent pigment exhibits a color by reflected light and emitted light, and a non-fluorescent pigment exhibits a color only by reflected light.

The green toner according to the present exemplary embodiment contains green toner particles. The green toner particles contain a binder resin, an azomethine fluorescent pigment having an emission peak in a wavelength region of 500 nm or more and 550 nm or less in the emission spectrum, and a non-fluorescent pigment having a reflection peak in a wavelength region of 480 nm or more and 540 nm or less in the reflection spectrum.

In other words, the green toner particles in the present exemplary embodiment are toner particles containing a yellow fluorescent pigment and a green pigment or a blue pigment.

Hereinafter, the “azomethine fluorescent pigment having an emission peak in the wavelength region of 500 nm or more and 550 nm or less in the emission spectrum” is referred to as an “azomethine fluorescent pigment (Y)”, and the “non-fluorescent pigment having a reflection peak in the wavelength region of 480 nm or more and 540 nm or less in the reflection spectrum” is referred to as a “pigment (G)”.

In the green toner particles in the present exemplary embodiment, the mass proportion of the azomethine fluorescent pigment (Y) in the green toner particles is 3% by mass or more and 20% by mass or less.

When the mass proportion of the azomethine fluorescent pigment (Y) is less than 3% by mass or more than 20% by mass, it may be difficult for the image to exhibit a desired green color, or density unevenness may occur in the image. The mass proportion of the azomethine fluorescent pigment (Y) is 3% by mass or more and 20% by mass or less, preferably 3% by mass or more and 15% by mass or less, more preferably 3% by mass or more and 10% by mass or less, from the viewpoints that an image exhibits a desired green color and that the uniformity of image density is excellent.

In the green toner particles in the present exemplary embodiment, the mass proportion of the azomethine fluorescent pigment (Y) in the total of the content of the azomethine fluorescent pigment (Y) and the content of the pigment (G) is preferably 30% by mass or more and 90% by mass or less, more preferably 35% by mass or more and 80% by mass or less, further preferably 40% by mass or more and 70% by mass or less, from the viewpoints that an image exhibits a desired green color and that the uniformity of image density is excellent.

In the green toner particles in the present exemplary embodiment, the total content of the azomethine fluorescent pigment (Y) and the pigment (G) is preferably 4% by mass or more and 25% by mass or less with respect to the total amount of the green toner particles.

When the total content of the two pigments is 4% by mass or more, the chroma of a green image is high. From the viewpoint of enhancing the chroma of the green image, the total content of the two pigments is preferably 4% by mass or more, more preferably 5% by mass or more, still more preferably 6% by mass or more.

When the total content of the two pigments is 25% by mass or less, the brightness of the green image is high. From the viewpoint of enhancing the brightness of the green image, the total content of the two pigments is preferably 25% by mass or less, more preferably 20% by mass or less, still more preferably 15% by mass or less.

The difference in wavelength between the emission peak of the azomethine fluorescent pigment (Y) having the maximum content among azomethine fluorescent pigments (Y) contained in the green toner particles in the present exemplary embodiment and the reflection peak of the pigment (G) having the maximum content among pigments (G) contained in the green toner particles is preferably 40 nm or less from the viewpoint of enhancing the brightness and chroma of the green image. The difference in wavelength between the emission peak and the reflection peak is preferably as small as possible, more preferably 30 nm or less, still more preferably 20 nm or less, still more preferably 10 nm or less, still more preferably 5 nm or less, ideally 0 nm.

In all the combinations of the emission peak of the azomethine fluorescent pigment (Y) and the reflection peak of the pigment (G) contained in the green toner particles in the present exemplary embodiment, the difference in wavelength between the emission peak and the reflection peak is preferably 40 nm or less from the viewpoint of enhancing the brightness and chroma of the green image. The difference in wavelength between the emission peak and the reflection peak is preferably as small as possible, more preferably 30 nm or less, still more preferably 20 nm or less, still more preferably 10 nm or less, still more preferably 5 nm or less, ideally 0 nm.

The color difference ΔE between the color when a solid image (an image having a density of 100%) is formed on coated paper using the green toner according to the present exemplary embodiment and a color sample TOKA FLASH VIVA DX 650 (T&K TOKA Corporation) in the CIE1976 L*a*b* color space is preferably 13.5 or less. The color difference ΔE is preferably as small as possible, more preferably 10 or less, still more preferably 6.5 or less, still more preferably 3 or less, still more preferably 1 or less, ideally 0.

In the present exemplary embodiment, the color difference ΔE between the image formed using the green toner and a color sample TOKA FLASH VIVA DX 650 (T&K TOKA Corporation) in the CIE1976 L*a*b* color space is defined by the following equation.

$$Δ E = \sqrt{{( {L}_{1} - {L}_{2} )}^{2} + {( {a}_{1} - {a}_{2} )}^{2} + {( {b}_{1} - {b}_{2} )}^{2}}$$

In the equation, L₁, a₁, and b₁ and L₂, a₂, and b₂ are an L* value, an a* value, and a b* value in the CIE1976 L*a*b* color space. L₁, a₁, and b₁ are the L* value, a* value, and b* value of the color sample TOKA FLASH VIVA DX 650, and are values obtained by subjecting the color sample TOKA FLASH VIVA DX 650 to measurement using a reflection spectrodensitometer. L₂, a₂, and b₂ are the L* value, a* value, and b* value of the image formed using the green toner, and are values obtained by subjecting the image to measurement using a reflection spectrodensitometer. The color sample TOKA FLASH VIVA DX 650 (T&K TOKA Corporation) is a color sample in which an image is formed on coated paper. The image formed using the green toner is also formed on coated paper, and the color difference ΔE is measured.

In the present exemplary embodiment, the coordinate values of the green toner in the CIE1976 L*a*b* color space are measured by the following method.

A green toner as a sample is mixed with a carrier and then put into a developing device of an image forming apparatus, and a solid image (an image having a density of 100%) having an applied toner amount of 4.0 g/m² is formed on coated paper at a fixing temperature of 180° C. The coordinate values of the formed solid image in the CIE1976 L*a*b* color space are measured at 10 random positions using a reflection spectrodensitometer, and the average values of the L* value, a* value, and b* value are calculated.

The reflectance of the reflection peak in the spectral reflection spectrum of a solid image formed on coated paper using the green toner according to the present exemplary embodiment is preferably 70% or more.

The green toner according to the present exemplary embodiment includes silica particles externally added to the green toner particles, and the average primary particle size of the silica particles is 50 nm or more and 350 nm or less. The silica particles having an average primary particle size of 50 nm or more and 350 nm or less act as spacers on the surfaces of the green toner particles to suppress aggregation of the green toner particles, thereby suppressing formation of color spots in an image.

If the average primary particle size of the silica particles is less than 50 nm, the silica particles are easily embedded in the green toner particles, which weakens the function as a spacer. The average primary particle size of the silica particles is 50 nm or more, preferably 70 nm or more, more preferably 90 nm or more, still more preferably 100 nm or more, from the viewpoint that the silica particles are less likely to be embedded in the green toner particles.

If the average primary particle size of the silica particles is more than 350 nm, charging of the green toner may be reduced, which may cause density unevenness in an image. The average primary particle size of the silica particles is 350 nm or less, preferably 300 nm or less, more preferably 200 nm or less, still more preferably 150 nm or less, from the viewpoint of excellent chargeability of the green toner and excellent evenness of image density.

In the green toner according to the present exemplary embodiment, {average primary particle size of silica particles/volume average particle size of green toner particles×100} is preferably 0.5 or more and 7 or less, more preferably 0.8 or more and 5 or less, still more preferably 1 or more and 3 or less.

Hereinafter, the configuration of the green toner according to the present exemplary embodiment will be described in detail.

### [Green Toner Particles]

The green toner particles contain a binder resin, an azomethine fluorescent pigment (Y), and a pigment (G), and if necessary, a release agent and other additives.

### —Azomethine Fluorescent Pigment (Y)—

The azomethine fluorescent pigment (Y) has an emission peak in a wavelength region of 500 nm or more and 550 nm or less in the emission spectrum. The emission peak of the azomethine fluorescent pigment (Y) is preferably in a wavelength region of 505 nm or more and 540 nm or less, more preferably in a wavelength region of 510 nm or more and 535 nm or less, still more preferably in a wavelength region of 515 nm or more and 530 nm or less.

The azomethine fluorescent pigment (Y) is a pigment having an azomethine structure (that is, —R¹C═N—, R¹ represents a hydrogen atom or a monovalent substituent) in the molecule. The azomethine fluorescent pigment (Y) is preferably bisazomethine, that is, a compound having —R¹C═N—N═CR²— (R¹ and R² each independently represent a hydrogen atom or a monovalent substituent) in the molecule.

Examples of the azomethine fluorescent pigment (Y) include the following azomethine compounds (1) to (3).

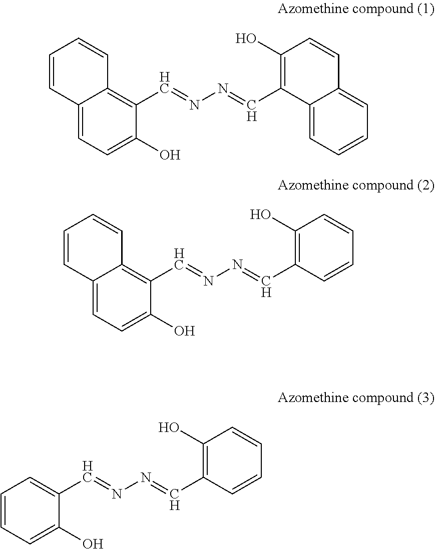 [SMILES: Oc1ccc2ccccc2c1/C=N/N=C/c1c(O)ccc2ccccc12 ; Oc1ccccc1/C=N/N=C/c1c(O)ccc2ccccc12 ; Oc1ccccc1/C=N/N=C/c1ccccc1O]

The emission peak of the azomethine compound (1) is 520 nm.

The emission peak of the azomethine compound (2) is 510 nm.

The emission peak of the azomethine compound (3) is 520 nm.

The azomethine fluorescent pigment (Y) is preferably at least one selected from the group consisting of the azomethine compound (1), the azomethine compound (2), and the azomethine compound (3).

The azomethine fluorescent pigment (Y) is preferably C.I. Pigment Yellow 101. C.I. Pigment Yellow 101 is the azomethine compound (1).

The volume average particle size D1 of the azomethine fluorescent pigments (Y) is preferably 50 nm or more and 800 nm or less, more preferably 150 nm or more and 600 nm or less, and still more preferably 250 nm or more and 400 nm or less, from the viewpoint of achieving dispersibility in toner particles, colorability on recording media, fixability to recording media, and the like in a well-balanced manner.

The volume average particle size of a pigment is measured with the pigment dispersed in an aqueous solution of a surfactant using a laser diffraction particle size distribution analyzer (for example, LA-700 manufactured by HORIBA, Ltd.). The volume-based particle size distribution is plotted from the small particle size side, and the particle size at which the cumulative volume of particles is 50% is taken as the volume average particle size.

### —Pigment (G)—

The pigment (G) has a reflection peak in a wavelength region of 480 nm or more and 540 nm or less in the reflection spectrum. The reflection peak of the pigment (G) is preferably in a wavelength region of 485 nm or more and 535 nm or less, more preferably in a wavelength region of 490 nm or more and 530 nm or less, still more preferably in a wavelength region of 495 nm or more and 525 nm or less.

Examples of the pigment (G) include halogenated phthalocyanine compounds and lake pigments of triphenylmethane dyes. The pigment (G) is preferably a halogenated phthalocyanine compound.

As the pigment (G), halogenated phthalocyanine compounds are preferable, and at least one selected from the group consisting of halogenated copper phthalocyanine and halogenated zinc phthalocyanine is preferable.

Examples of the halogenated copper phthalocyanine include C.I. Pigment Green 7 (reflection peak: 500 nm), C.I. Pigment Green 36 (reflection peak: 510 nm), and C.I. Pigment Blue 76 (reflection peak: 490 nm).

Examples of the halogenated zinc phthalocyanine include C.I. Pigment Green 58 (reflection peak: 515 nm) and C.I. Pigment Green 59 (reflection peak: 520 nm).

The pigment (G) is preferably at least one selected from the group consisting of C.I. Pigment Green 7, C.I. Pigment Green 36, C.I. Pigment Green 58, C.I. Pigment Green 59, and C.I. Pigment Blue 76.

The volume average particle size D2 of the pigment (G) is preferably 50 nm or more and 300 nm or less, more preferably 100 nm or more and 250 nm or less, still more preferably 120 nm or more and 200 nm or less, from the viewpoint of achieving dispersibility in toner particles, colorability on recording media, fixability to recording media, and the like in a well-balanced manner.

The volume average particle size of a pigment is measured with the pigment dispersed in an aqueous solution of a surfactant using a laser diffraction particle size distribution analyzer (for example, LA-700 manufactured by HORIBA, Ltd.). The volume-based particle size distribution is plotted from the small particle size side, and the particle size at which the cumulative volume of particles is 50% is taken as the volume average particle size.

The ratio D1/D2 of the volume average particle size D1 of the azomethine fluorescent pigment (Y) to the volume average particle size D2 of the pigment (G) is preferably 1 or more and 3 or less, more preferably 1.2 or more and 2.5 or less, still more preferably 1.5 or more and 2 or less, from the viewpoint of enhancing the brightness and chroma of the green image.

The green toner particles may contain colorants other than the azomethine fluorescent pigment (Y) and the pigment (G).

The total amount of the azomethine fluorescent pigment (Y) and the pigment (G) in the total amount of colorants contained in the green toner particles is preferably 90% by mass or more, more preferably 95% by mass or more, still more preferably 100% by mass.

### —Binder Resin—

Examples of the binder resin include vinyl resins containing homopolymers of monomers such as styrenes (for example, styrene, para-chlorostyrene, and α-methylstyrene), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (for example, acrylonitrile and methacrylonitrile), vinyl ethers (for example, vinyl methyl ether and vinyl isobutyl ether), vinyl ketones (for example, vinyl methyl ketone, vinyl ethyl ketone, and vinyl isopropenyl ketone), and olefins (for example, ethylene, propylene, and butadiene), or copolymers obtained by combining two or more of these monomers.

Examples of the binder resin also include non-vinyl resins such as an epoxy resin, a polyester resin, a polyurethane resin, a polyamide resin, a cellulose resin, a polyether resin, and a modified rosin, mixtures of these and the vinyl resins, and graft polymers obtained by polymerizing vinyl monomers in the presence of these.

These binder resins may be used singly or in combination of two or more kinds thereof.

A polyester resin is suitable as the binder resin.

Examples of the polyester resin include known polyester resins.

Examples of the polyester resin include a condensation polymer of a polycarboxylic acid and a polyhydric alcohol. As the polyester resin, a commercially available product may be used, or a synthesized product may be used.

Examples of the polycarboxylic acid include aliphatic dicarboxylic acid (for example, oxalic acid, malonic acid, maleic acid, fumaric acid, citraconic acid, itaconic acid, glutaconic acid, succinic acid, alkenylsuccinic acid, adipic acid, and sebacic acid), alicyclic dicarboxylic acids (for example, cyclohexanedicarboxylic acid), aromatic dicarboxylic acids (for example, terephthalic acid, isophthalic acid, phthalic acid, and naphthalenedicarboxylic acid), anhydrides thereof, or lower alkyl (for example, having 1 or more and 5 or less carbon atoms) esters thereof. Among these, for example, aromatic dicarboxylic acids are preferable as the polycarboxylic acid.

As the polycarboxylic acid, a tri- or higher carboxylic acid having a crosslinked structure or a branched structure may be used together with the dicarboxylic acids. Examples of the tri- or higher carboxylic acid include trimellitic acid, pyromellitic acid, anhydrides thereof, or lower alkyl (for example, having 1 or more and 5 or less carbon atoms) esters thereof.

The polycarboxylic acids may be used singly or in combination of two or more kinds thereof.

Examples of the polyhydric alcohol include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, ethylene oxide adduct of bisphenol A and propylene oxide adduct of bisphenol A). Among these, as the polyhydric alcohol, for example, aromatic diols and alicyclic diols are preferable, and aromatic diols are more preferable.

As the polyhydric alcohol, a trihydric or higher polyhydric alcohol having a crosslinked structure or a branched structure may be used together with the diols. Examples of the trihydric or higher polyhydric alcohol include glycerin, trimethylolpropane, and pentaerythritol.

The polyhydric alcohols may be used singly or in combination of two or more kinds thereof.

The glass transition temperature (Tg) of the polyester resin is preferably 50° C. or more and 80° C. or less, more preferably 50° C. or more and 65° C. or less.

The glass transition temperature is determined from a DSC curve obtained by differential scanning calorimetry (DSC), and more specifically, is determined by “extrapolated glass transition starting temperature” described in the method for determining a glass transition temperature in JIS K 7121:1987 “Testing methods for transition temperatures of plastics”.

The weight average molecular weight (Mw) of the polyester resin is preferably 5000 or more and 1000000 or less, more preferably 7000 or more and 500000 or less.

The number average molecular weight (Mn) of the polyester resin is preferably 2000 or more and 100000 or less.

The molecular weight distribution Mw/Mn of the polyester resin is preferably 1.5 or more and 100 or less, more preferably 2 or more and 60 or less.

The weight average molecular weight and the number average molecular weight are measured by gel permeation chromatography (GPC). The molecular weight measurement by GPC is performed with a THF solvent, using a GPC HLC-8120GPC manufactured by Tosoh Corporation as a measurement instrument and a column TSKgel SuperHM-M (15 cm) manufactured by Tosoh Corporation. The weight average molecular weight and the number average molecular weight are calculated from the measurement results using a molecular weight calibration curve created with monodisperse polystyrene standard samples.

The polyester resin is obtained by a known production method. Specifically, for example, the polyester resin is obtained by a method in which the polymerization temperature is set to 180° C. or more and 230° C. or less, the pressure in the reaction system is reduced if necessary, and the reaction is conducted while water or an alcohol generated at the time of condensation is removed.

In a case where the raw material monomers are not dissolved or compatibilized at the reaction temperature, a solvent having a high boiling point may be added as a solubilizing agent to dissolve the monomers. In this case, the polycondensation reaction is conducted while the solubilizing agent is distilled off. In a case where a monomer having poor compatibility is present, the monomer having poor compatibility and an acid or alcohol to be polycondensed with the monomer may be condensed in advance, and then the resultant product may be polycondensed with the main component.

The content of the binder resin is preferably 40% by mass or more and 95% by mass or less, more preferably 50% by mass or more and 90% by mass or less, still more preferably 60% by mass or more and 85% by mass or less with respect to the total amount of the toner particles.

### —Release Agent—

Examples of the release agent include hydrocarbon-based waxes; natural waxes such as carnauba wax, rice wax, and candelilla wax; synthetic or mineral/petroleum-based waxes such as montan wax; and ester-based waxes such as fatty acid esters and montanic acid esters. The release agent is not limited thereto.

The melting temperature of the release agent is preferably 50° C. or more and 110° C. or less, more preferably 60° C. or more and 100° C. or less.

The melting temperature is determined from a DSC curve obtained by differential scanning calorimetry (DSC) according to “melting peak temperature” described in a method for determining a melting temperature in JIS K 7121:1987 “Testing methods for transition temperatures of plastics”.

The content of the release agent is preferably 1% by mass or more and 20% by mass or less, more preferably 5% by mass or more and 15% by mass or less with respect to the total amount of the toner particles.

### —Other Additives—

Examples of other additives include known additives such as a magnetic material, a charge control agent, and an inorganic powder. These additives are contained in the toner particles as internal additives.

### —Characteristics of Toner Particles—

The toner particles may be toner particles having a single-layer structure or toner particles having a so-called core-shell structure including a core (core particle) and a covering layer (shell layer) covering the core.

The toner particles having a core-shell structure may include, for example, a core containing a binder resin and, if necessary, other additives such as a colorant and a release agent, and a covering layer containing a binder resin.

The volume average particle size (D50v) of the toner particles is preferably 2 μm or more and 10 μm or less, more preferably 4 μm or more and 8 μm or less.

Various average particle sizes and various particle size distribution indices of the toner particles are measured using Coulter Multisizer II (manufactured by Beckman Coulter, Inc.) and ISOTON-II (manufactured by Beckman Coulter, Inc.) as an electrolytic solution.

In the measurement, 0.5 mg or more and 50 mg or less of a measurement sample is added to 2 ml of a 5% by mass aqueous solution of a surfactant (preferably sodium alkylbenzene sulfonate) as a dispersant. This is added to 100 ml or more and 150 ml or less of the electrolytic solution.

The electrolytic solution in which the sample is suspended is subjected to a dispersion treatment for 1 minute using an ultrasonic disperser, and the particle size distribution of particles having a particle size in a range of 2 μm or more and 60 μm or less is measured using Coulter Multisizer II and an aperture having an aperture diameter of 100 μm. The number of particles to be sampled is 50,000.

Cumulative distributions of volumes and numbers are plotted from the small size side with respect to the particle size ranges (channels) divided on the basis of the measured particle size distribution, and the particle sizes at which the cumulative volume and cumulative number of particles are 16% are defined as a volume particle size D16v and a number particle size D16p, respectively, the particle sizes at which the cumulative volume and cumulative number of particles are 50% are defined as a volume average particle size D50v and a cumulative number average particle size D50p, respectively, and the particle sizes at which the cumulative volume and cumulative number of particles are 84% are defined as a volume particle size D84v and a number particle size D84p, respectively.

Using these, the volume-based particle size distribution index (GSDv) is calculated as (D84v/D16v)^{1/2} and the number-based particle size distribution index (GSDp) is calculated as (D84p/D16p)^{1/2}.

The average circularity of the toner particles is preferably 0.94 or more and 1.00 or less, more preferably 0.95 or more and 0.98 or less.

The average circularity of the toner particles is determined by (circle-equivalent perimeter)/(perimeter) [(perimeter of circle having same projected area as particle image)/(perimeter of particle projected image)]. Specifically, the average circularity is a value measured by the following method.

First, the average circularity is determined with a flow-type particle image analyzer (FPIA-3000 manufactured by Sysmex Corporation) that suctions and collects toner particles to be measured, forms a flat flow, captures a particle image as a still image by instantaneously emitting strobe light, and performs image analysis of the particle image. The number of samples for determining the average circularity is 3500.

In a case where the toner contains an external additive, the toner (developer) to be measured is dispersed in water containing a surfactant and then subjected to ultrasonic treatment to obtain toner particles from which the external additive has been removed.

### [Silica Particles]

The green toner according to the present exemplary embodiment contains silica particles as an external additive. Examples of the silica particles include fumed silica particles, sol-gel silica particles, and mixtures thereof.

A method for producing fumed silica particles is publicly known. A sol-gel method for producing sol-gel silica particles is publicly known. The sol-gel method includes, for example, preparing a silica sol suspension by adding aqueous ammonia dropwise to a mixed solution of tetraalkoxysilane, water, and an alcohol, centrifuging wet silica gel from the silica sol suspension, and drying the wet silica gel to obtain silica particles. Examples of the tetraalkoxysilane include tetramethoxysilane, tetraethoxysilane, tetrapropoxysilane, and tetrabutoxysilane.

The surfaces of the silica particles are preferably subjected to hydrophobization treatment. The hydrophobization treatment is performed, for example, by immersing the silica particles in a hydrophobizing agent. The hydrophobizing agent is not particularly limited, and examples thereof include a silane-based coupling agent, silicone oil, a titanate-based coupling agent, and an aluminum-based coupling agent. These may be used singly or in combination of two or more kinds thereof. The amount of the hydrophobizing agent is, for example, 1 part by mass or more and 10 parts by mass or less relative to 100 parts by mass of the silica particles.

The average primary particle size of the silica particles is 50 nm or more and 350 nm or less, preferably 70 nm or more and 300 nm or less, more preferably 90 nm or more and 200 nm or less, and still more preferably 100 nm or more and 150 nm or less, from the viewpoint of spacer effect and toner chargeability.

The average primary particle size of the silica particles can be controlled by, for example, the amounts of materials used and the dropping time in the sol-gel method.

The average circularity of the silica particles is preferably 0.70 or more and 1.00 or less, more preferably 0.80 or more and 1.00 or less, still more preferably 0.90 or more and 1.00 or less, from the viewpoint of easily rolling on the green toner particles.

The average primary particle size and the average circularity of the silica particles are determined as follows.

An image of the green toner is captured at a magnification of 40,000-fold using a scanning electron microscope (SEM) (S-4800, manufactured by Hitachi High-Tech Corporation) equipped with an energy dispersive X-ray spectrometer (EDX apparatus) (EMAX Evolution X-Max 80 mm², manufactured by HORIBA, Ltd.). From one visual field, 500 primary particles of the silica particles are identified based on the presence of silicon atoms and oxygen atoms by EDX analysis. The images of 500 silica particles are analyzed with image processing analysis software WinRoof (Mitani Corporation) to determine the circle-equivalent diameter, area, and perimeter of each primary particle. In the number-based distribution of the circle-equivalent diameter, the circle-equivalent diameter at which the cumulative number of particles is 50% from the small size side is taken as the average primary particle size. The circularity is expressed as follows: Circularity=4π×(Area of particle image)/(Perimeter of particle image)². In the number-based distribution of circularity, the circularity at which the cumulative number of particles is 50% from the small size side is taken as the average circularity.

In the green toner according to the present exemplary embodiment, when the green toner is dispersed in water containing a surfactant, the amount of silica particles detached from the green toner particles is preferably 10% by mass or more and 30% by mass or less of the silica particles externally added to the green toner particles. The mass proportion of the silica particles is also referred to as a proportion of weakly attached silica particles.

When the proportion of weakly attached silica particles is 10% by mass or more, the silica particles easily roll on the green toner particles, which easily suppresses the formation of color spots. From this point of view, the proportion of weakly attached silica particles is more preferably 12% by mass or more, still more preferably 15% by mass or more.

When the proportion of weakly attached silica particles is 30% by mass or less, the uniformity of image density is excellent. From this point of view, the proportion of weakly attached silica particles is more preferably 25% by mass or less, still more preferably 20% by mass or less.

The proportion of weakly attached silica particles is determined as follows.

(1) Only green toner particles (3 g) constituting a green toner are molded into pellets having a diameter of 30 mm and a thickness of 2 mm using an automatic pressure molding machine (BRE-32, manufactured by Maekawa Testing Machine Mfg. Co., Ltd.) under conditions of a load of 10 t and a pressure time of 60 seconds. This is used as a sample (0).

(2) A green toner (3 g) is molded into pellets in the same manner as in (1). This is used as a sample (b).

(3) An aqueous surfactant solution containing 0.5% by mass of a surfactant NOIGEN ET-165 (DKS Co., Ltd.) in ion-exchanged water is prepared. The aqueous surfactant solution is put into a 100 mL glass beaker by 50 mL, the green toner is added thereto by 4 g, and the mixture is stirred using a magnetic stirrer at a rotation speed of 100 rpm for 5 minutes to prepare a toner dispersion. The toner dispersion is subjected to centrifugal separation (rotation radius: 10 cm, rotation speed: 3000 rpm, 2 minutes), and a supernatant liquid (containing silica particles weakly attached to toner particles) is removed. A dispersion prepared by adding 50 mL of ion-exchanged water to the sediment is subjected to suction filtration using a suction filter and filter paper (Filter Paper No. 5C 60 φm/m for Kiriyama funnel, Kiriyama Glass Works Co.), and the resulting solid remaining on the filter paper is collected. A dispersion prepared again by adding 50 mL of ion-exchanged water to the solid is subjected to suction filtration, and the resulting solid remaining on the filter paper is collected. The solid is left to stand in a thermostat bath at a temperature of 40° C. for 12 hours for drying. Three grams of the dried product is molded into pellets in the same manner as in (1). This is used to as a sample (a).

(4) Quantitative analysis of silicon is performed on each of the sample (0), the sample (b), and the sample (a) with a fluorescent X-ray analyzer (ZSX-100e, Rigaku Corporation). A calibration curve for silicon is prepared in advance, and the silicon amount is calculated using the calibration curve. When the silicon amount of the sample (0) is C0, the silicon amount of the sample (b) is Cb, and the silicon amount of the sample (a) is Ca, the proportion of weakly attached silica particles is calculated from the following equation.

Proportion of weakly attached silica particles (% by mass)=(Cb−Ca)/(Cb−C0)×100

In the green toner according to the present exemplary embodiment, when the green toner is dispersed in water containing a surfactant and subjected to ultrasonic treatment at a power of 40 W and a frequency of 20 kHz for 10 minute, silica particles that are not detached from the green toner particles are preferably 1% by mass or more and 5% by mass or less of the silica particles externally added to the green toner particles. The mass proportion of the silica particles is also referred to as a proportion of strongly attached silica particles.

When the proportion of strongly attached silica particles is 1% by mass or more, uniformity of image density is excellent. From this point of view, the proportion of strongly attached silica particles is more preferably 2% by mass or more, still more preferably 3% by mass or more.

When the proportion of strongly attached silica particles is 5% by mass or less, the silica particles easily roll on the green toner particles, which easily suppresses the formation of color spots. From this point of view, the proportion of strongly attached silica particles is more preferably 4% by mass or less.

The proportion of strongly attached silica particles is determined as follows.

(1) Only green toner particles (3 g) constituting a green toner are molded into pellets having a diameter of 30 mm and a thickness of 2 mm using an automatic pressure molding machine (BRE-32, manufactured by Maekawa Testing Machine Mfg. Co., Ltd.) under conditions of a load of 10 t and a pressure time of 60 seconds. This is used as a sample (0).

(2) A green toner (3 g) is molded into pellets in the same manner as in (1). This is used as a sample (b).

(3) An aqueous surfactant solution containing 0.5% by mass of a surfactant NOIGEN ET-165 (DKS Co., Ltd.) in ion-exchanged water is prepared. The aqueous surfactant solution is put into a 100 mL glass beaker by 50 mL, the green toner is added thereto by 4 g, and the mixture is stirred using a magnetic stirrer at a rotation speed of 100 rpm for 5 minutes to prepare a toner dispersion. A probe of an ultrasonic homogenizer VCX750 (Sonics and Materials, Inc.) is inserted into the toner dispersion (inserted until the distance between the tip of the probe and the bottom of the beaker becomes 1.0 cm), and an ultrasonic wave (power: 40 W, frequency: 20 kHz) is applied for 10 minutes. The toner dispersion is subjected to centrifugal separation (rotation radius: 10 cm, rotation speed: 3000 rpm, 2 minutes), and a supernatant liquid is removed. A dispersion prepared by adding 50 mL of ion-exchanged water to the sediment (containing silica particles strongly attached to the toner particles) is subjected to suction filtration using a suction filter and filter paper (Filter Paper No. 5C 60 φm/m for Kiriyama funnel, Kiriyama Glass Works Co.), and the resulting solid remaining on the filter paper is collected. A dispersion prepared again by adding 50 mL of ion-exchanged water to the solid is subjected to suction filtration, and the resulting solid remaining on the filter paper is collected. The solid is left to stand in a thermostat bath at a temperature of 40° C. for 12 hours for drying. Three grams of the dried product is molded into pellets in the same manner as in (1). This is used to as a sample (a).

(4) Quantitative analysis of silicon is performed on each of the sample (0), the sample (b), and the sample (a) with a fluorescent X-ray analyzer (ZSX-100e, Rigaku Corporation). A calibration curve for silicon is prepared in advance, and the silicon amount is calculated using the calibration curve. When the silicon amount of the sample (0) is C0, the silicon amount of the sample (b) is Cb, and the silicon amount of the sample (a) is Ca, the proportion of strongly attached silica particles is calculated from the following equation.

Proportion of strongly attached silica particles (% by mass)=(Ca−C0)/(Cb−C0)×100

The proportion of weakly attached silica particles and the proportion of strongly attached silica particles can be controlled by adjusting the rotation speed and/or rotation time of a blender or mixer when the green toner particles and the silica particles are mixed.

The amount of the silica particles externally added is preferably 0.5 parts by mass or more and 5 parts by mass or less, more preferably 0.8 parts by mass or more and 4 parts by mass or less, still more preferably 1 part by mass or more and 3 parts by mass or less with respect to 100 parts by mass of the green toner particles from the viewpoint of suppressing formation of color spots in an image.

The content of the silica particles is preferably 50% by mass or more and 100% by mass or less with respect to the total amount of the external additives contained in the green toner.

### [Other External Additives]

The green toner according to the present exemplary embodiment may contain external additives other than the silica particles. Examples of the external additives other than the silica particles include inorganic particles such as SrTiO₃, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, and MgSO₄.

The surfaces of the inorganic particles are preferably subjected to hydrophobization treatment. The hydrophobization treatment is performed, for example, by immersing the inorganic particles in a hydrophobizing agent. The hydrophobizing agent is not particularly limited, and examples thereof include a silane-based coupling agent, silicone oil, a titanate-based coupling agent, and an aluminum-based coupling agent. These may be used singly or in combination of two or more kinds thereof.

Examples of the external additives also include resin particles (resin particles of polystyrene, polymethyl methacrylate, melamine resin, and the like) and cleaning activators (for example, metal salts of higher fatty acids represented by zinc stearate, and particles of fluorine-based high molecular weight compounds).

In a case where the green toner according to the present exemplary embodiment contains external additives other than the silica particles, the amount of the other external additives externally added is preferably 0.01 parts by mass or more and 5 parts by mass or less, more preferably 0.01 parts by mass or more and 2 parts by mass or less with respect to 100 parts by mass of the toner particles.

### [Method for Producing Green Toner]

The green toner according to the present exemplary embodiment is obtained by producing green toner particles and then externally adding external additives to the green toner particles. The external additives include at least silica particles.

The green toner particles may be produced by any one of a dry production process (for example, a kneading-pulverizing process) or a wet production process (for example, an aggregation-coalescence process, a suspension polymerization process, and a dissolution suspension process). These production processes are not particularly limited, and known production processes are employed. Among these, the toner particles may be obtained by the aggregation-coalescence process.

In a case where the green toner particles are produced by an aggregation-coalescence process, the following production method is preferable.

The production method includes a step of preparing a resin particle dispersion in which resin particles serving as a binder resin are dispersed (resin particle dispersion preparing step);
a step of preparing a fluorescent pigment (Y) dispersion in which an azomethine fluorescent pigment (Y) is dispersed (fluorescent pigment (Y) dispersion preparing step);
a step of preparing a pigment (G) dispersion in which a pigment (G) is dispersed (pigment (G) dispersion preparing step);
a step of forming aggregated particles by aggregating mixed particles in a mixed dispersion in which the resin particle dispersion, the fluorescent pigment (Y) dispersion, and the pigment (G) dispersion are mixed (aggregated particle forming step); and
a step of forming green toner particles by heating the aggregated particle dispersion in which aggregated particles are dispersed and thus fusing and coalescing the aggregated particles (fusing and coalescing step).

Hereinafter, details of each step will be described. In the following description, the green toner particles are simply referred to as toner particles. In the following description, a method for obtaining toner particles containing a release agent is described, but the release agent is used if necessary.

### —Resin Particle Dispersion Preparing Step—

The resin particle dispersion is prepared, for example, by dispersing resin particles in a dispersion medium with a surfactant.

Examples of the dispersion medium that is used in the resin particle dispersion include aqueous media.

Examples of the aqueous media include water such as distilled water and ion-exchanged water and alcohols. These may be used singly or in combination of two or more kinds thereof.

Examples of the surfactant include anionic surfactants such as sulfates, sulfonates, phosphates, and soaps; cationic surfactants such as amine salts and quaternary ammonium salts; and nonionic surfactants such as polyethylene glycol, alkylphenol-ethylene oxide adducts, and polyhydric alcohols. Among these, anionic surfactants and cationic surfactants are particularly exemplified. A nonionic surfactant may be used in combination with an anionic surfactant or a cationic surfactant.

The surfactants may be used singly or in combination of two or more kinds thereof.

In the resin particle dispersion, examples of a method for dispersing resin particles in a dispersion medium include general dispersion methods using, for example, a rotary shear-type homogenizer or a ball mill, a sand mill, or a dyno mill having media. Depending on the kind of resin particles, the resin particles may be dispersed in a dispersion medium by a phase inversion emulsification method. The phase inversion emulsification method is a method in which a resin to be dispersed is dissolved in a hydrophobic organic solvent in which the resin is soluble, a base is added to the organic continuous phase (O phase) for neutralization, and then an aqueous medium (W phase) is added to perform phase inversion from W/O to O/W, thereby dispersing the resin in the aqueous medium in the form of particles.

The volume average particle size of the resin particles dispersed in the resin particle dispersion is, for example, preferably 0.01 μm or more and 1 μm or less, more preferably 0.08 μm or more and 0.8 μm or less, still more preferably 0.1 μm or more and 0.6 μm or less. The volume average particle size of the resin particles is measured as follows: using the particle size distribution obtained through measurement with a laser diffraction particle size distribution analyzer (for example, LA-700 manufactured by HORIBA, Ltd.), the cumulative distribution of volume is plotted from the small particle size side with respect to the divided particle size ranges (channels), and the particle size at which the cumulative volume of particles is 50% with respect to all the particles is taken as the volume average particle size D50v. The volume average particle size of particles in other dispersions is also measured in the same manner.

The content of the resin particles contained in the resin particle dispersion is preferably 5% by mass or more and 50% by mass or less, more preferably 10% by mass or more and 40% by mass or less.

The method for preparing the release agent particle dispersion is the same as that for the resin particle dispersion. The content of the release agent particles contained in the release agent particle dispersion is preferably 5% by mass or more and 50% by mass or less, more preferably 10% by mass or more and 40% by mass or less.

### —Fluorescent Pigment (Y) Dispersion Preparing Step—

The fluorescent pigment (Y) dispersion is prepared, for example, by dispersing the azomethine fluorescent pigment (Y) in a dispersion medium with a surfactant.

Examples of the dispersion medium that is used in the fluorescent pigment (Y) dispersion include aqueous media.

Examples of the aqueous media include water such as distilled water and ion-exchanged water and alcohols. These may be used singly or in combination of two or more kinds thereof.

Examples of the surfactant include anionic surfactants such as sulfates, sulfonates, phosphates, and soaps; cationic surfactants such as amine salts and quaternary ammonium salts; and nonionic surfactants such as polyethylene glycol, alkylphenol-ethylene oxide adducts, and polyhydric alcohols. Among these, anionic surfactants and cationic surfactants are particularly exemplified. A nonionic surfactant may be used in combination with an anionic surfactant or a cationic surfactant.

The surfactants may be used singly or in combination of two or more kinds thereof.

Examples of the method for dispersing the azomethine fluorescent pigment (Y) in the dispersion medium include dispersion methods using, for example, a rotary shear-type homogenizer or a ball mill, a sand mill, a dyno mill, or a key mill having media.

The volume average particle size of the azomethine fluorescent pigment (Y) dispersed in the fluorescent pigment (Y) dispersion is, for example, preferably 30 nm or more and 800 nm or less, more preferably 50 nm or more and 700 nm or less, still more preferably 150 nm or more and 600 nm or less, still more preferably 250 nm or more and 400 nm or less. The particle size of the azomethine fluorescent pigment (Y) can be adjusted, for example, by the method and time of dispersion treatment.

The content of the azomethine fluorescent pigment (Y) contained in the fluorescent pigment (Y) dispersion is preferably 5% by mass or more and 50% by mass or less, more preferably 10% by mass or more and 40% by mass or less.

### —Pigment (G) Dispersion Preparing Step—

The pigment (G) dispersion is prepared, for example, by dispersing the pigment (G) in a dispersion medium with a surfactant.

Examples of the dispersion medium that is used in the pigment (G) dispersion include aqueous media.

Examples of the aqueous media include water such as distilled water and ion-exchanged water and alcohols. These may be used singly or in combination of two or more kinds thereof.

Examples of the surfactant include anionic surfactants such as sulfates, sulfonates, phosphates, and soaps; cationic surfactants such as amine salts and quaternary ammonium salts; and nonionic surfactants such as polyethylene glycol, alkylphenol-ethylene oxide adducts, and polyhydric alcohols. Among these, anionic surfactants and cationic surfactants are particularly exemplified. A nonionic surfactant may be used in combination with an anionic surfactant or a cationic surfactant.

The surfactants may be used singly or in combination of two or more kinds thereof.

Examples of the method for dispersing the pigment (G) in the dispersion medium include dispersion methods using, for example, a rotary shear-type homogenizer or a ball mill, a sand mill, a dyno mill, or a key mill having media.

The volume average particle size of the pigment (G) dispersed in the pigment (G) dispersion is, for example, preferably 20 nm or more and 400 nm or less, more preferably 50 nm or more and 300 nm or less, still more preferably 100 nm or more and 250 nm or less, still more preferably 120 nm or more and 200 nm or less. The particle size of the pigment (G) can be adjusted by, for example, the method and time of dispersion treatment.

The content of the pigment (G) contained in the pigment (G) dispersion is preferably 5% by mass or more and 50% by mass or less, more preferably 10% by mass or more and 40% by mass or less.

### —Aggregated Particle Forming Step—

The resin particle dispersion, the fluorescent pigment (Y) dispersion, the pigment (G) dispersion, and the release agent particle dispersion are mixed together. Then, the resin particles, the azomethine fluorescent pigment (Y), the pigment (G), and the release agent particles are heteroaggregated in the mixed dispersion to form aggregated particles, which have a size close to the target toner particle size and contain the resin particles, the azomethine fluorescent pigment (Y), the pigment (G), and the release agent particles.

Specifically, for example, an aggregating agent is added to the mixed dispersion as well as the pH of the mixed dispersion is adjusted to be acidic (for example, a pH of 2 or more and 5 or less), a dispersion stabilizer is added if necessary, and then heating is performed to a temperature close to the glass transition temperature of the resin particles (specifically, for example, a temperature that is equal to or higher than (the glass transition temperature of the resin particles−30° C.) and equal to or lower than (the glass transition temperature−10° C.)) to aggregate the particles dispersed in the mixed dispersion, thereby forming aggregated particles.

In the aggregated particle forming step, for example, heating may be performed after an aggregating agent is added at room temperature (for example, 25° C.) while the mixed dispersion is stirred using a rotary shear-type homogenizer, the pH of the mixed dispersion is adjusted to be acidic (for example, a pH of 2 or more and 5 or less), and a dispersion stabilizer is added if necessary.

Examples of the aggregating agent include a surfactant having a polarity opposite to that of the surfactant contained in the mixed dispersion, an inorganic metal salt, and a divalent or higher valent metal complex. In a case where a metal complex is used as the aggregating agent, the amount of the surfactant used decreases, and the charging characteristics are improved.

Together with the aggregating agent, an additive, which forms a complex or a similar bond with a metal ion of the aggregating agent, may be used if necessary. A chelating agent is suitably used as this additive.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may be used. Examples of the chelating agent include oxycarboxylic acids such as tartaric acid, citric acid, and gluconic acid; and aminocarboxylic acids such as iminodiacetic acid (IDA), nitrilotriacetic acid (NTA), and ethylenediaminetetraacetic acid (EDTA).

The amount of the chelating agent added is preferably 0.01 parts by mass or more and 5.0 parts by mass or less, more preferably 0.1 parts by mass or more and less than 3.0 parts by mass with respect to 100 parts by mass of the resin particles.

### —Fusing and Coalescing Step—

Next, the aggregated particle dispersion in which aggregated particles are dispersed is heated, for example, to a temperature higher than or equal to the glass transition temperature of the resin particles (for example, a temperature higher than the glass transition temperature of the resin particles by 10° C. to 30° C.) to fuse and coalesce the aggregated particles, thereby forming toner particles.

Through the above-described steps, toner particles are obtained.

The toner particles may be produced, after an aggregated particle dispersion in which aggregated particles are dispersed is obtained, through a step of forming second aggregated particles by further mixing the aggregated particle dispersion with a resin particle dispersion in which resin particles are dispersed and aggregating the particles so that the resin particles are further attached to the surfaces of the aggregated particles and a step of forming toner particles having a core-shell structure by heating the second aggregated particle dispersion in which the second aggregated particles are dispersed and thus fusing and coalescing the second aggregated particles.

After the fusing and coalescing step is terminated, the toner particles in the dispersion are subjected to known washing, solid-liquid separation, and drying steps to obtain dry toner particles. In the washing step, displacement washing with ion-exchanged water may be sufficiently performed from the viewpoint of chargeability. In the solid-liquid separation step, suction filtration, pressure filtration, or the like may be performed from the viewpoint of productivity. In the drying step, freeze drying, flash drying, fluidized drying, vibration-type fluidized drying, or the like may be performed from the viewpoint of productivity.

The toner according to the present exemplary embodiment is produced by, for example, adding an external additive to the obtained dry toner particles and performing mixing. The mixing may be performed using, for example, a V-blender, a Henschel mixer, or a Lödige mixer. Furthermore, coarse particles of the toner may be removed by using a vibration sieving machine, a wind force sieving machine, or the like, if necessary.

When the toner particles and the silica particles are mixed, the proportion of weakly attached silica particles and the proportion of strongly attached silica particles are controlled by adjusting the rotation speed and/or the rotation time of a blender or a mixer.

### <Electrostatic Charge Image Developer>

The electrostatic charge image developer according to the present exemplary embodiment contains at least the green toner according to the present exemplary embodiment.

The electrostatic charge image developer according to the present exemplary embodiment may be a one-component developer containing only the green toner according to the present exemplary embodiment, or a two-component developer in which the green toner and a carrier are mixed.

The carrier is not particularly limited, and examples thereof include known carriers. Examples of the carrier include a covered carrier in which the surface of a core material formed of a magnetic powder is covered with a resin; a magnetic powder-dispersed carrier in which a magnetic powder is dispersed and blended in a matrix resin; and a resin-impregnated carrier in which a porous magnetic powder is impregnated with a resin.

The magnetic powder-dispersed carrier and the resin-impregnated carrier may be carriers in which constitutional particles of the carriers are core materials and the surfaces are covered with a resin.

Examples of the magnetic powder include magnetic metals such as iron, nickel, and cobalt; and magnetic oxides such as ferrite and magnetite.

Examples of the covering resin and the matrix resin include polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymer, styrene-acrylic acid ester copolymer, a straight silicone resin containing an organosiloxane bond or modified products thereof, a fluororesin, polyester, polycarbonate, a phenol resin, an epoxy resin, and an acrylic resin.

The covering resin and the matrix resin may contain other additives such as conductive particles. Examples of the conductive particles include particles of metals such as gold, silver, and copper, carbon black, titanium oxide, zinc oxide, tin oxide, barium sulfate, aluminum borate, and potassium titanate. Examples of other additives include silica particles.

The surface of the core material is covered with a resin by, for example, a method in which a covering layer forming solution in which a covering resin and various additives (used if necessary) are dissolved in an appropriate solvent is used for covering. The solvent is not particularly limited, and may be selected in consideration of the kind of resin to be used, coating suitability, and the like.

Specific examples of the resin covering method include an immersion method in which the core material is immersed in the covering layer forming solution; a spray method in which the covering layer forming solution is sprayed on the surface of the core material; a fluidized bed method in which the covering layer forming solution is sprayed in a state where the core material is floated by fluidized air; and a kneader coater method in which the core material of the carrier and the covering layer forming solution are mixed in a kneader coater and then the solvent is removed.

The mixing ratio (mass ratio) of the green toner to the carrier in the two-component developer is preferably green toner:carrier=1:100 to 30:100, more preferably 3:100 to 20:100.

### <Image Forming Apparatus and Image Forming Method>

The image forming apparatus and image forming method according to the present exemplary embodiment will be described.

The image forming apparatus according to the present exemplary embodiment includes an image holding member, charging means that charges a surface of the image holding member, electrostatic charge image forming means that forms an electrostatic charge image on the surface of the charged image holding member, developing means that accommodates an electrostatic charge image developer and develops the electrostatic charge image formed on the surface of the image holding member into a toner image with the electrostatic charge image developer, transfer means that transfers the toner image formed on the surface of the image holding member onto the surface of a recording medium, and fixing means that fixes the toner image transferred on the surface of the recording medium. The electrostatic charge image developer according to the present exemplary embodiment is applied as the electrostatic charge image developer.

In the image forming apparatus according to the present exemplary embodiment, an image forming method (the image forming method according to the present exemplary embodiment) including a charging step of charging a surface of an image holding member; an electrostatic charge image forming step of forming an electrostatic charge image on the charged surface of the image holding member; a developing step of developing the electrostatic charge image formed on the surface of the image holding member into a toner image with the electrostatic charge image developer according to the present exemplary embodiment; a transfer step of transferring the toner image formed on the surface of the image holding member onto a surface of a recording medium; and a fixing step of fixing the toner image transferred on the surface of the recording medium is implemented.

As the image forming apparatus according to the present exemplary embodiment, known image forming apparatuses are applied, such as a direct transfer type apparatus which directly transfers a toner image formed on a surface of an image holding member to a recording medium; an intermediate transfer type apparatus which primarily transfers a toner image formed on the surface of an image holding member to a surface of an intermediate transfer member and secondarily transfers the toner image transferred on the surface of the intermediate transfer member onto a surface of a recording medium; an apparatus including cleaning means that cleans the surface of the image holding member after transfer of the toner image and before charging; and an apparatus including charge-erasing means that irradiates the surface of the image holding member with charge-erasing light after transfer of the toner image and before charging.

In a case where the image forming apparatus according to the present exemplary embodiment is an intermediate transfer type apparatus, the transfer means includes, for example, an intermediate transfer member in which a toner image is transferred onto the surface, primary transfer means that primarily transfers the toner image formed on the surface of an image holding member onto the surface of an intermediate transfer member, and secondary transfer means that secondarily transfers the toner image transferred on the surface of the intermediate transfer member onto the surface of a recording medium is applied.

In the image forming apparatus according to the present exemplary embodiment, for example, a portion including the developing means may have a cartridge structure (process cartridge) that is detachably attached to the image forming apparatus. As the process cartridge, for example, a process cartridge that accommodates the electrostatic charge image developer according to the present exemplary embodiment and includes developing means is suitably used.

Hereinafter, an example of the image forming apparatus according to the present exemplary embodiment will be described, but the image forming apparatus is not limited thereto. In the following description, main parts illustrated in the drawings will be described, and description of the other parts will be omitted.

In the following description, as an example of the image forming apparatus according to the present exemplary embodiment, a six-unit tandem-type image forming apparatus in which six image forming units are arranged will be described. The tandem-type image forming apparatus is not limited thereto, and may be a five-unit tandem-type image forming apparatus in which five image forming units are arranged, a four-unit tandem-type image forming apparatus in which four image forming units are arranged, or the like.

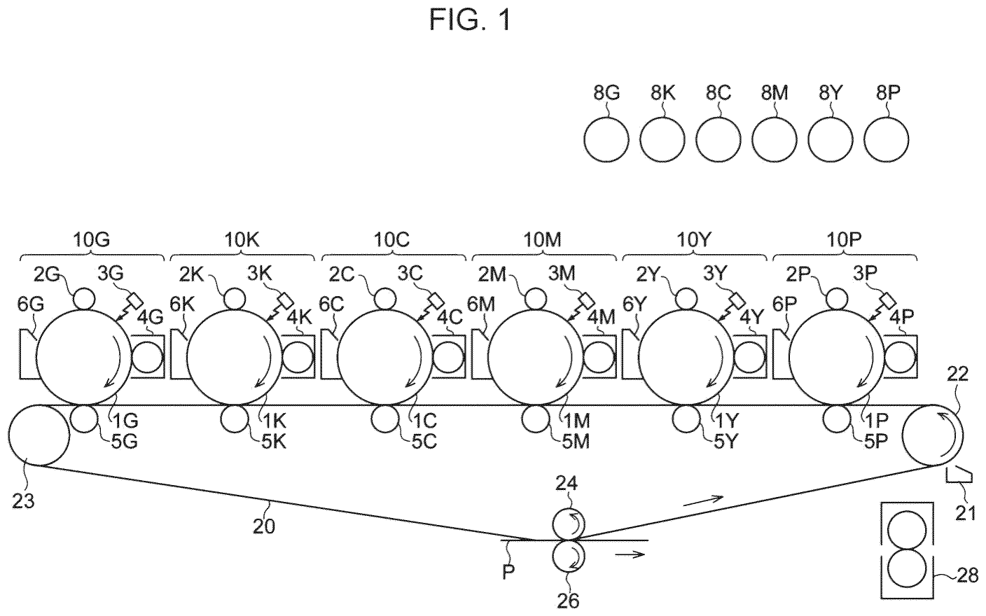

FIG. 1 is a schematic configuration diagram illustrating the image forming apparatus according to the present exemplary embodiment, and is a diagram illustrating an image forming apparatus of a six-unit tandem type and an intermediate transfer type.

The image forming apparatus illustrated in FIG. 1 includes first to sixth image forming units 10P, 10Y, 10M, 10C, 10K, and 10G, which are electrophotographic image forming means that output images of respective colors of pink (P), yellow (Y), magenta (M), cyan (C), black (K), and green (G) based on the color-separated image data. These image forming units (hereinafter may be simply referred to as “units”) 10P, 10Y, 10M, 10C, 10K, and 10G are horizontally disposed side by side at predetermined intervals. These units 10P, 10Y, 10M, 10C, 10K, and 10G may be process cartridges detachably attached to the image forming apparatus.

Below the units 10P, 10Y, 10M, 10C, 10K, and 10G, an intermediate transfer belt (an example of the intermediate transfer member) 20 extends through each of the units. The intermediate transfer belt 20 is wound around a driving roller 22, a supporting roller 23, and a counter roller 24, which are in contact with the inner surface of the intermediate transfer belt 20, so as to run in the direction from the first unit 10P toward the sixth unit 10G. An intermediate transfer member cleaning device 21 is provided on the image holding surface side of the intermediate transfer belt 20 so as to face the driving roller 22.

The toners of pink, yellow, magenta, cyan, black, and green accommodated in toner cartridges 8P, 8Y, 8M, 8C, 8K, and 8G are respectively supplied to developing devices (an example of the developing means) 4P, 4Y, 4M, 4C, 4K, and 4G of the units 10P, 10Y, 10M, 10C, 10K, and 10G.

Since the first to sixth units 10P, 10Y, 10M, 10C, 10K, and 10G have the same configuration and operation, the sixth unit 10G that forms a green image will be described here as a representative.

The sixth unit 10G includes a photoreceptor 1G acting as an image holding member. Around the photoreceptor 1G, a charging roller (an example of the charging means) 2G that charges the surface of the photoreceptor 1G to a predetermined potential, an exposure device (an example of the electrostatic charge image forming means) 3G that forms an electrostatic charge image by exposing the charged surface to a laser beam based on a color-separated image signal, a developing device (an example of the developing means) 4G that develops the electrostatic charge image by supplying a toner to the electrostatic charge image, a primary transfer roller (an example of the primary transfer means) 5G that transfers the developed toner image onto the intermediate transfer belt 20, and a photoreceptor cleaning device (an example of the cleaning means) 6G that removes toner remaining on the surface of the photoreceptor 1G after the primary transfer are disposed in this order.

The primary transfer roller 5G is disposed inside the intermediate transfer belt 20 and is provided at a position facing the photoreceptor 1G. A bias power source (not illustrated) that applies a primary transfer bias is connected to each of primary transfer rollers 5Y, 5P, 5M, 5C, 5G, and 5K of the respective units. Each bias power source changes the value of the transfer bias applied to each primary transfer roller through control by a control section (not illustrated).

Hereinafter, an operation of forming a green image in the sixth unit 10G will be described.

First, prior to the operation, the surface of the photoreceptor 1G is charged to a potential of −600 V to −800 V by the charging roller 2G.

The photoreceptor 1G is formed by stacking a photosensitive layer on an electrically conductive (for example, a volume resistivity of 1×10⁻⁶ Ωcm or less at 20° C.) substrate. The photosensitive layer usually has a high resistance (resistance of a general resin), but has a property that the specific resistance of a portion irradiated with a laser beam changes when the portion is irradiated with the laser beam. Then, the charged surface of the photoreceptor 1G is irradiated with a laser beam from the exposure device 3G in accordance with the green image data sent from the control section (not illustrated). Thus, an electrostatic charge image of a green image pattern is formed on the surface of the photoreceptor 1G.

The electrostatic charge image is an image formed on the surface of the photoreceptor 1G by charging, and is a so-called negative latent image formed by the fact that the specific resistance of the irradiated portion of the photosensitive layer is decreased by the laser beam from the exposure device 3G, the charges on the surface of the photoreceptor 1G flow, and the charges at the portions not irradiated with the laser beam remain.

The electrostatic charge image formed on the photoreceptor 1G rotates to a predetermined developing position as the photoreceptor 1G runs. Then, at the developing position, the electrostatic charge image on the photoreceptor 1G is developed into a toner image by the developing device 4G to be visualized.

In the developing device 4G, for example, an electrostatic charge image developer containing at least a green toner and a carrier is accommodated. The green toner is triboelectrically charged by being stirred inside the developing device 4G, has a charge of the same polarity (negative polarity) as the charge on the photoreceptor 1G, and is held on a developer roller (an example of the developer holding member). Next, as the surface of the photoreceptor 1G passes through the developing device 4G, the green toner electrostatically adheres to the charge-erased latent image portion on the surface of the photoreceptor 1G, and the latent image is developed with the green toner. The photoreceptor 1G on which the green toner image has been formed is continuously run at a predetermined speed, and the toner image developed on the photoreceptor 1G is conveyed to a predetermined primary transfer position.

When the green toner image on the photoreceptor 1G is conveyed to the primary transfer position, a primary transfer bias is applied to the primary transfer roller 5G, the electrostatic force directed from the photoreceptor 1G to the primary transfer roller 5G acts on the toner image, and the toner image on the photoreceptor 1G is transferred onto the intermediate transfer belt 20. The transfer bias applied at this time has a (+) polarity opposite to the (−) polarity of the toner, and is controlled to, for example, +10 μA by the control section (not illustrated) in the sixth unit 10G.

The photoreceptor 1G from which the toner image has been transferred onto the intermediate transfer belt 20 continues rotating and comes into contact with a cleaning blade provided in the photoreceptor cleaning device 6G. Toner remaining on the photoreceptor 1G is removed and collected by the photoreceptor cleaning device 6G.

The intermediate transfer belt 20 is sequentially conveyed through the first to sixth image forming units 10P, 10Y, 10M, 10C, 10K, and 10G, and the toner images of the respective colors are transferred in a superimposed manner.

The intermediate transfer belt 20 on which the toner images of six colors are transferred in a superimposed manner while passing through the first to sixth units reaches a secondary transfer portion constituted by the intermediate transfer belt 20, the counter roller 24 in contact with the inner surface of the intermediate transfer belt, and a secondary transfer roller (an example of the secondary transfer means) 26 disposed on the image holding surface side of the intermediate transfer belt 20. Meanwhile, a recording sheet (an example of the recording medium) P is fed to a gap between the second transfer roller 26 and the intermediate transfer belt 20 in contact with each other at predetermined timing via a supply mechanism, and a secondary transfer bias is applied to the counter roller 24. The transfer bias applied at this time has the same (−) polarity as the (−) polarity of the toner. The electrostatic force directed from the intermediate transfer belt 20 toward the recording sheet P acts on the toner image, and the toner image on the intermediate transfer belt 20 is transferred onto the recording sheet P. The secondary transfer bias at this time is determined in accordance with the resistance detected by resistance detecting means (not illustrated) that detects the resistance of the secondary transfer portion, and is voltage-controlled.

The intermediate transfer belt 20 from which the toner image has been transferred onto the recording sheet P continues running, and comes into contact with a cleaning blade provided in the intermediate transfer member cleaning device 21. The toner remaining on the intermediate transfer belt 20 is removed and collected by the intermediate transfer member cleaning device 21.

The recording sheet P on which the toner image has been transferred is fed into a pressure-contact portion (nip portion) between a pair of fixing rollers in a fixing device (an example of the fixing means) 28, and the toner image is fixed onto the recording sheet P, thereby forming a fixed image.

Examples of the recording sheet P onto which the toner image is transferred include plain paper used in electrophotographic copying machines, printers, and the like. Examples of the recording medium include an OHP sheet in addition to the recording sheet P.

In order to further improve the smoothness of the image surface after fixing, the surface of the recording sheet P is also preferably smooth, and for example, coated paper obtained by coating the surface of plain paper with a resin or the like, art paper for printing, and the like are suitably used.

The recording sheet P on which the color image has been fixed is taken out toward a discharge section, and a series of color image forming operations is finished.

### <Process Cartridge and Toner Cartridge>

The process cartridge according to the present exemplary embodiment will be described.

The process cartridge according to the present exemplary embodiment is a process cartridge, which includes developing means that accommodates the electrostatic charge image developer according to the present exemplary embodiment and develops an electrostatic charge image formed on the surface of an image holding member into a toner image with the electrostatic charge image developer, and is detachably attached to an image forming apparatus.

The process cartridge according to the present exemplary embodiment is not limited to the above configuration, and may include developing means and, if necessary, at least one selected from other means such as an image holding member, charging means, electrostatic charge image forming means, and transfer means.

Hereinafter, an example of the process cartridge according to the present exemplary embodiment will be described, but the process cartridge is not limited thereto. In the following description, main parts illustrated in the drawings will be described, and description of the other parts will be omitted.

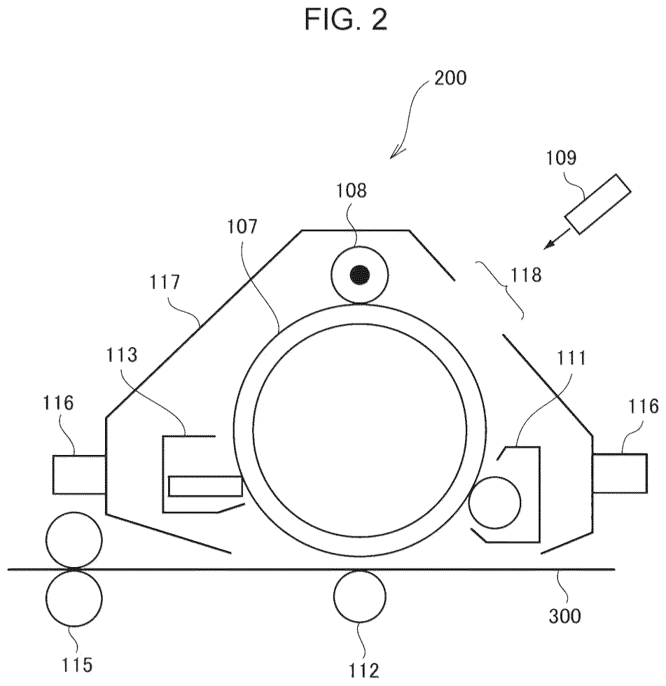

FIG. 2 is a schematic configuration diagram illustrating the process cartridge according to the present exemplary embodiment.

A process cartridge 200 illustrated in FIG. 2 is configured as a cartridge, for example, by integrally combining and holding a photoreceptor 107 (an example of the image holding member), a charging roller 108 (an example of the charging means) provided around the photoreceptor 107, a developing device 111 (an example of the developing means), and a photoreceptor cleaning device 113 (an example of the cleaning means) in a housing 117 provided with attachment rails 116 and an opening 118 for exposure.

In FIG. 2, 109 denotes an exposure device (an example of the electrostatic charge image forming means), 112 denotes a transfer device (an example of the transfer means), 115 denotes a fixing device (an example of the fixing means), and 300 denotes a recording sheet (an example of the recording medium).

Next, the toner cartridge according to the present exemplary embodiment will be described.

The toner cartridge according to the present exemplary embodiment is a toner cartridge which accommodates the green toner according to the present exemplary embodiment and is detachably attached to an image forming apparatus. The toner cartridge accommodates replenishment toner to be supplied to the developing means provided in the image forming apparatus.

The image forming apparatus illustrated in FIG. 1 is an image forming apparatus having a configuration in which the toner cartridges 8Y, 8P, 8M, 8C, 8G, and 8K are detachably attached, and the developing devices 4Y, 4P, 4M, 4C, 4G, and 4K are connected to the toner cartridges corresponding to the respective colors through toner supplying tubes (not illustrated). In a case where the amount of toner accommodated in the toner cartridge becomes small, the toner cartridge is replaced. An example of the toner cartridge according to the present exemplary embodiment is a toner cartridge 8G in which the green toner according to the present exemplary embodiment is accommodated. The toner cartridges 8P, 8Y, 8M, 8C, and 8K accommodate pink, yellow, magenta, cyan, and black toners, respectively.

### EXAMPLES

Hereinafter, exemplary embodiments of the present invention will be described in detail with reference to Examples, but the exemplary embodiments of the present invention are not limited to these Examples.

In the following description, unless otherwise particularly stated, “parts” and “%” are based on mass.

Synthesis, treatment, production, and the like are performed at room temperature (25° C.±3° C.) unless otherwise stated.

### <Production of Carrier>

Cyclohexyl methacrylate (weight average molecular weight: 50000): 54 parts
Carbon black (Cabot Corporation, VXC72): 6 parts
Toluene: 250 parts
Isopropyl alcohol: 50 parts

The above materials and glass beads (1 mm in diameter, the same amount as that of toluene) are placed in a sand mill and stirred at a rotation speed of 190 rpm for 30 minutes to obtain a coating agent.

In a kneader, 1000 parts of ferrite particles (volume average particle size: 35 μm) and 150 parts of the coating agent are placed and mixed at room temperature (25° C.) for 20 minutes. The mixture is then heated to 70° C. and dried under reduced pressure. The dried product is cooled to room temperature (25° C.), taken out from the kneader, and sieved through a mesh having an opening of 75 μm to remove coarse powder, thereby obtaining a carrier.

### <Production of Silica Particles>

### [Silica Particles (S1)]

In a glass reaction vessel equipped with a stirrer, a dropping nozzle, and a thermometer, 300 parts of methanol and 70 parts of 10% aqueous ammonia are charged and mixed to obtain an alkaline catalyst solution. The alkaline catalyst solution is adjusted to 30° C., and 169 parts of tetramethoxysilane (TMOS) and 45 parts of 8.0% aqueous ammonia are simultaneously added dropwise thereto with stirring to obtain a silica particle dispersion (solid content: 12.0%). Herein, the dropping time is 29 minutes. Then, the silica particle dispersion is condensed to a solid content of 40% using a rotary filter to obtain a silica particle dispersion (S1).

To 250 parts of the silica particle dispersion (S1), 62 parts of hexamethyldisilazane (HMDS) serving as a hydrophobizing agent is added, the temperature is adjusted to 130° C., and the reaction is caused for 2 hours. Subsequently, the temperature is decreased to room temperature and spray drying is performed to obtain hydrophobic silica particles (S1).

### [Silica Particles (S2) to (S5)]

Silica particles (S2) to (S5) are produced in the same manner as in the production of the silica particles (S1), except that the amounts of methanol, 10% aqueous ammonia, TMOS, and 8% aqueous ammonia used, the dropping time of TMOS and 8% aqueous ammonia, and the amount of HMDS used are changed to the specifications in Table 1. Table 1 shows the average primary particle size and the average circularity of the silica particles.

TABLE 1

| | Preparation of silica particle dispersion | | | | | | | Silica particles | |
|---|---|---|---|---|---|---|---|---|---|
| | | 10% | | 8% | | Hydrophobizing | | Average | |
| Silica | | aqueous | | aqueous | | agent | | primary | |
| particles | Methanol | ammonia | TOMS | ammonia | Dripping | | Amount | particle | Average |
| Name | Parts by | Parts by | Parts by | Parts by | time | Type | Parts by | size | circularity |
| — | mass | mass | mass | mass | Minute | — | mass | nm | — |
| S1 | 300 | 70 | 169 | 45 | 29 | HMDS | 62 | 110 | 0.97 |
| S2 | 300 | 70 | 330 | 100 | 80 | HMDS | 60 | 350 | 0.91 |
| S3 | 300 | 50 | 100 | 25 | 15 | HMDS | 60 | 50 | 0.80 |
| S4 | 300 | 45 | 100 | 20 | 10 | HMDS | 50 | 25 | 0.70 |
| S5 | 300 | 75 | 350 | 110 | 90 | HMDS | 60 | 400 | 0.91 |

### Example 1: Green Toner and Green Developer

### [Preparation of Resin Particle Dispersion (1)]

Terephthalic acid: 30 parts by mole
Fumaric acid: 70 parts by mole
Bisphenol A ethylene oxide adduct: 5 parts by mole
Bisphenol A propylene oxide adduct: 95 parts by mole

A flask equipped with a stirrer, a nitrogen inlet tube, a temperature sensor, and a rectifying column is charged with the above materials, and the temperature is raised to 220° C. over 1 hour. After it is confirmed that the inside of the reaction system is uniformly stirred, 1 part of titanium tetraethoxide is added with respect to 100 parts of the above materials. The temperature is raised to 230° C. over 30 minutes while generated water is distilled off. Stirring is continuously performed at a temperature of 230° C. for 1 hour, and then the inside of the reaction system is cooled to room temperature. Thus, an amorphous polyester resin (weight average molecular weight: 18,000, glass transition temperature: 60° C.) is obtained.

After 40 parts of ethyl acetate and 25 parts of 2-butanol are put into a reaction vessel equipped with temperature control means and nitrogen purging means and mixed, 100 parts of the amorphous polyester resin is gradually added and dissolved. Subsequently, 3 molar equivalents of a 10% aqueous ammonia solution with respect to the acid value of the amorphous polyester resin is added, and the mixture is stirred for 30 minutes. Next, the inside of the reaction vessel is purged with dry nitrogen, and 400 part of ion-exchanged water is added dropwise at a rate of 2 parts/min while the temperature is maintained at 40° C. and stirring is performed to prepare a resin particle dispersion. The resin particle dispersion is cooled to room temperature and bubbled with a dry nitrogen gas for 48 hours while stirring is performed to decrease the concentrations of ethyl acetate and 2-butanol to 1000 ppm or less. Ion-exchanged water is added to the resin particle dispersion to obtain a resin particle dispersion (1) having a solid content of 20%.

### [Preparation of Release Agent Particle Dispersion (1)]

Paraffin wax (HNP-9, NIPPON SEIRO Co., Ltd.): 100 parts
Anionic surfactant (NEOGEN RK, DKS Co., Ltd.): 1 part
Ion-exchanged water: 350 parts

The above materials are mixed, heated to 100° C., dispersed using a homogenizer (ULTRA-TURRAX T50, IKA), and then dispersed using a pressure-discharge homogenizer (Gaulin). When the volume average particle size reaches 200 nm, collection is performed to obtain a release agent particle dispersion (1) having a solid content of 20%.

### [Preparation of Pigment Dispersion (Y101)]

C.I. Pigment Yellow 101:70 parts
Anionic surfactant (NEOGEN RK, DKS Co., Ltd.): 30 parts (solid content: 20%)
Ion-exchanged water: 200 parts

The above materials are mixed and pulverized using a continuous key mill (KMC-3, INOUE Mfg., Inc.) until the volume average particle size reaches 300 nm. The solid content is adjusted to 20% to obtain a pigment dispersion (Y101).

### [Preparation of Pigment Dispersion (PG36)]

C.I. Pigment Green 36:70 parts
Anionic surfactant (NEOGEN RK, DKS Co., Ltd.): 30 parts (solid content: 20%)
Ion-exchanged water: 200 parts

The above materials are mixed and pulverized using a continuous key mill (KMC-3, INOUE Mfg., Inc.) until the volume average particle size reaches 150 nm. The solid content is adjusted to 20% to obtain a pigment dispersion (PG36).

### [Preparation of Green Toner Particles]

Resin particle dispersion (1): 400 parts (solid content: 20%)
Release agent particle dispersion (1): 25 parts (solid content: 20%)
Pigment dispersion (Y101): 20 parts (solid content: 20%)
Pigment dispersion (PG36): 20 parts (solid content: 20%)
Anionic surfactant (NEOGEN RK, DKS Co., Ltd.): 12 parts (solid content: 20%)

The above materials are placed in a round stainless steel flask, the pH is adjusted to 3.5 by addition of 0.1 mol/L nitric acid, and 30 parts of nitric acid having a polyaluminum chloride concentration of 10% is added. The liquid temperature is adjusted to 30° C., dispersion treatment is performed using a homogenizer (ULTRA-TURRAX T50, IKA), and the mixture is heated to 45° C. in a heating oil bath while the inside of the flask is stirred and held for 30 minutes. Next, 50 parts of the resin particle dispersion (1) (solid content: 20%) is further added, the mixture is held for 1 hour, then the pH is adjusted to 8.5 using a 0.1 mol/L aqueous sodium hydroxide solution, and the mixture is heated to 84° C. while stirring is continuously performed and held for 2.5 hours. Next, the mixture is cooled to room temperature at a rate of 20° C./min and subjected to solid-liquid separation, and washing with ion-exchanged water is sufficiently performed. The solid is vacuum-dried to obtain green toner particles (1). The volume average particle size of the green toner particles (1) is 5.8 μm.

### [Preparation of Green Toner and Green Developer]

In a sample mill, 100 parts of the green toner particles (1) and 1.7 parts of the silica particles (S1) are placed, and mixed at a rotation speed of 10000 rpm for 30 seconds. Thereafter, the mixture is sieved through a vibration sieve having an opening of 45 μm to obtain a toner with external additives.

In a V-blender, 10 parts of the toner with external additives and 100 parts of the carrier are placed, and stirred for 20 minutes. Thereafter, the mixture is sieved through a sieve having an opening of 212 μm to obtain a green developer.

### Examples 2 and 3 and Comparative Examples 1 and 2

Green toner particles, a green toner, and a green developer are produced in the same manner as in Example 1, except that the silica particles (S1) are replaced with any one of the silica particles (S2) to (S5).

### Examples 4 to 8

Green toner particles, a green toner, and a green developer are produced in the same manner as in Example 1, except that the rotation speed and the rotation time of the sample mill during the mixing of the green toner particles (1) and the silica particles (S1) are changed.

### Example 9

Green toner particles, a green toner, and a green developer are produced in the same manner as in Example 1, except that C.I. Pigment Green 36 is replaced with C.I. Pigment Green 7 in the production of the green toner particles.

### Examples 10 to 12 and Comparative Examples 3 to 5

Green toner particles, a green toner, and a green developer are produced in the same manner as in Example 1, except that the amount of the pigment dispersion used is changed in the production of the green toner particles.

### <Performance Evaluation>

### [Color Forming Property]

A modified machine of DocuCentreColor 400 (FUJIFILM Business Innovation Corp.) is provided, a developer is placed in the developing device, and a toner is placed in the toner cartridge.

In an environment at a temperature of 22° C. and a relative humidity of 55%, a green monochrome solid image (density: 100%, size: 5 cm×5 cm, applied toner amount: 4.0 g/m²) is formed on A4 coated paper (OS coated paper, 127 g/m², FUJIFILM Business Innovation Corp.).

Using a reflection spectrodensitometer X-Rite 938 (X-Rite, Incorporated), the L* value, a* value, and b* value in the CIE 1976 L*a*b* color space are measured at central portions in the solid image. Furthermore, the chroma C* is calculated from the following equation.

$${{{Chroma C *= \{ ( a \text{*)}}^{2} + ( b \text{*)}}^{2} \}}^{0.5}$$

The color forming property is classified as follows from the chroma C* and the brightness L*. Table 2 shows the results.
G1: The chroma C* is 97 or more and the brightness L* is 80 or more.
G2: The chroma C* is 95 or more and the brightness L′ is 78 or more.
G3: The chroma C* is less than 95 and/or the brightness L′ is less than 78.

### [Reflectance]

A modified machine of DocuCentreColor 400 (FUJIFILM Business Innovation Corp.) is provided, a developer is placed in the developing device, and a toner is placed in the toner cartridge.

In an environment at a temperature of 22° C. and a relative humidity of 55%, a green monochrome solid image (density: 100%, size: 5 cm×5 cm, applied toner amount: 4.0 g/m²) is formed on A4 coated paper (OS coated paper, 127 g/m², FUJIFILM Business Innovation Corp.).

Using a reflection spectrodensitometer X-Rite 938 (X-Rite, Incorporated), the spectral reflectance (400 nm to 700 nm) is measured at central portions in the solid image. The spectral reflectance at a wavelength of 530 nm is classified as follows. Table 2 shows the results.
G1: 95% or more
G2: 90% or more and less than 95%
G3: less than 90%

### [Uniformity of Image Density]

A modified machine of DocuCentreColor 400 (FUJIFILM Business Innovation Corp.) is provided, a developer is placed in the developing device, and a toner is placed in the toner cartridge.

In an environment at a temperature of 28° C. and a relative humidity of 85%, which is an environment in which a toner is relatively less likely to be charged, five green monochrome solid images (density: 100%, size: 5 cm×5 cm) are formed on a single sheet of A4 coated paper (OS coated paper, 127 g/m², FUJIFILM Business Innovation Corp.).

The image density ({(L*)²+(a*)²+(b*)²}^{0.5}) is measured at each of central portions of the five solid images using a reflection spectrodensitometer X-Rite 938 (X-Rite, Incorporated). The difference between the highest and the lowest of the five measurement values is calculated and classified as follows. Table 2 shows the results.
A: The difference in image density is less than 1.
B: The difference in image density is 1 or more and less than 3.
C: The difference in image density is 3 or more.

### [Color Spot]

A modified machine of DocuCentreColor 400 (FUJIFILM Business Innovation Corp.) is provided, a developer is placed in the developing device, and a toner is placed in the toner cartridge.

In an environment at a temperature of 22° C. and a relative humidity of 55%, a green monochrome halftone image (density: 25%, size: 5 cm×5 cm) is formed on A4 coated paper (OS coated paper, 127 g/m², FUJIFILM Business Innovation Corp.).

The halftone image is visually observed, and the number of color spots is classified as follows. Table 2 shows the results.
A: The number of color spots is 5 or less.
B: The number of color spots is 6 or more and 10 or less.
C: The number of color spots is 11 or more.

The symbols in Table 2 mean the following pigments.
PY101: C.I. Pigment Yellow 101 (Radiant Color, Radglo VSF-0-01, emission peak: 520 nm), one of azomethine fluorescent pigments (Y)
PG36: C.I. Pigment Green 36 (Toyo Color, LIONOL GREEN 8624, reflection peak: 510 nm, specific gravity: 2.9), one of pigments (G)
PG7: C.I. Pigment Green 7 (Toyo Color, LIONOL GREEN 8390, reflection peak: 500 nm, specific gravity: 2.1), one of pigments (G)

The specific gravities of the pigments are values measured by the following operation in conformity with 5-2-1 of JIS K0061: 2001.
(1) In a Le Chatelier pycnometer, 250 mL of ethyl alcohol is placed, and adjusted so that the meniscus aligns with the position of the scale.
(2) The pycnometer is immersed in a constant-temperature water bath. When the liquid temperature reaches 20.0° C.±0.2° C., the position of the meniscus is accurately read using the scale on the pycnometer (accuracy 0.0025 mL).
(3) A sample is weighed by 100 g.
(4) The weighed sample is placed in the pycnometer and defoamed.
(5) The pycnometer is immersed in a constant-temperature water bath. When the liquid temperature reaches 20.0° C.±0.2° C., the position of the meniscus is accurately read using the scale on the pycnometer (accuracy 0.0025 mL).
(6) The specific gravity is calculated from the following equation.

$$Equation : S = D / 0.9982$$

$$Equation : D = W / ( L 2 - L 1 )$$

Herein, S represents a specific gravity of the sample (20° C.), D represents a density of the sample (g/cm³, 20° C.), 0.9982 represents a water density at 20° C. (g/cm³), W represents an apparent mass of the sample (g), L1 represents a reading of the meniscus before the sample is placed in the pycnometer (mL, 20° C.), and L2 represents a reading of the meniscus after the sample is placed in the pycnometer (mL, 20° C.).

TABLE 2

| | Green toner particles | | | | | | | | | | | | | |
|---|---|---|---|---|---|---|---|---|---|---|---|---|---|---|
| | | | Non- | | | | Silica particles | | | | | | | |
| | Fluorescent | | fluorescent | | | Proportion of | | | Proportion | Proportion | | | | |
| | pigment | | pigment | | Pigment | fluorescent | | Average | of weakly | of strongly | Green toner | | | |
| | | Con- | | Con- | Total | pigment in | | primary | attached | attached | Color | Re- | Uniformity | |
| | | tent | | tent | content | pigments | | particle | particles | particles | forming | flec- | of image | Color |
| | Type | % by | Type | % by | % by | % by | Type | size | % by | % by | property | tance | density | spot |
| | — | mass | — | mass | mass | mass | — | nm | mass | mass | — | — | — | — |
| Comparative | PY101 | 3.5 | PG36 | 3.5 | 7.0 | 50 | S4 | 25 | 20 | 4 | G1 | G1 | A | C |
| Example 1 | | | | | | | | | | | | | | |
| Comparative | PY101 | 3.5 | PG36 | 3.5 | 7.0 | 50 | S5 | 400 | 20 | 4 | G1 | G2 | C | B |
| Example 2 | | | | | | | | | | | | | | |
| Example 1 | PY101 | 3.5 | PG36 | 3.5 | 7.0 | 50 | S1 | 110 | 20 | 4 | G1 | G1 | A | A |
| Example 2 | PY101 | 3.5 | PG36 | 3.5 | 7.0 | 50 | S2 | 350 | 20 | 4 | G1 | G2 | B | A |
| Example 3 | PY101 | 3.5 | PG36 | 3.5 | 7.0 | 50 | S3 | 50 | 20 | 4 | G1 | G2 | A | B |
| Example 4 | PY101 | 3.5 | PG36 | 3.5 | 7.0 | 50 | S1 | 110 | 9 | 6 | G1 | G1 | B | B |
| Example 5 | PY101 | 3.5 | PG36 | 3.5 | 7.0 | 50 | S1 | 110 | 10 | 6 | G1 | G1 | A | B |
| Example 6 | PY101 | 3.5 | PG36 | 3.5 | 7.0 | 50 | S1 | 110 | 30 | 0 | G1 | G1 | B | A |
| Example 7 | PY101 | 3.5 | PG36 | 3.5 | 7.0 | 50 | S1 | 110 | 20 | 1 | G1 | G1 | B | A |
| Example 8 | PY101 | 3.5 | PG36 | 3.5 | 7.0 | 50 | S1 | 110 | 20 | 5 | G1 | G1 | A | B |
| Example 9 | PY101 | 3.5 | PG7 | 3.5 | 7.0 | 50 | S1 | 110 | 20 | 4 | G2 | G1 | A | A |
| Example 10 | PY101 | 3.5 | PG36 | 10.5 | 14.0 | 25 | S1 | 110 | 20 | 4 | G1 | G2 | B | B |
| Example 11 | PY101 | 3.5 | PG36 | 0.2 | 3.7 | 95 | S1 | 110 | 20 | 4 | G1 | G2 | B | B |
| Example 12 | PY101 | 20 | PG36 | 1.3 | 21.3 | 94 | S1 | 110 | 20 | 4 | G2 | G1 | B | B |
| Comparative | PY101 | 3.0 | PG36 | 0 | 3.0 | 100 | S1 | 110 | 20 | 4 | G3 | G2 | B | B |
| Example 3 | | | | | | | | | | | | | | |
| Comparative | PY101 | 2.9 | PG36 | 0.2 | 3.1 | 94 | S1 | 110 | 20 | 4 | G3 | G3 | B | B |
| Example 4 | | | | | | | | | | | | | | |
| Comparative | PY101 | 21 | PG36 | 1.3 | 22.3 | 94 | S1 | 110 | 20 | 4 | G2 | G1 | C | B |
| Example 5 | | | | | | | | | | | | | | |

### <Image Formation Using Actual Machine>

A six-unit tandem-type image forming apparatus of an electrophotographic type and an intermediate transfer type is provided. Six developing devices are filled with a pink developer, a yellow developer, a magenta developer, a cyan developer, a black developer, and a green developer (the developer of Example 1), respectively. Then, an image is formed on A4 coated paper on the basis of image data obtained by color-separating RGB data into the six colors. An image having favorable color reproducibility close to the original RGB data is obtained.

The green toner for electrostatic charge image development, the electrostatic charge image developer, the toner cartridge, the process cartridge, the image forming apparatus, and the image forming method of the present disclosure include the following aspects.

### APPENDIX

(((1))) A green toner for electrostatic charge image development, comprising:
green toner particles containing a binder resin, an azomethine fluorescent pigment having an emission peak in a wavelength region of 500 nm or more and 550 nm or less in an emission spectrum, and a non-fluorescent pigment having a reflection peak in a wavelength region of 480 nm or more and 540 nm or less in a reflection spectrum, wherein a mass proportion of the azomethine fluorescent pigment in the green toner particles is 3% by mass or more and 20% by mass or less; and
silica particles externally added to the green toner particles,
wherein the silica particles have an average primary particle size of 50 nm or more and 350 nm or less.

(((2))) The green toner for electrostatic charge image development according to (((1))),
wherein a mass proportion of the azomethine fluorescent pigment in a total of a content of the azomethine fluorescent pigment and a content of the non-fluorescent pigment is 30% by mass or more and 90% by mass or less.

(((3))) The green toner for electrostatic charge image development according to (((1))) or (((2))),
wherein the silica particles are contained in an amount of 0.5 parts by mass or more and 5 parts by mass or less with respect to 100 parts by mass of the green toner particles. (((4))) The green toner for electrostatic charge image development according to any one of (((1))) to (((3))),
wherein silica particles detached from the green toner particles account for 10% by mass or more and 30% by mass or less of the silica particles externally added to the green toner particles when the green toner for electrostatic charge image development is dispersed in water containing a surfactant.

(((5))) The green toner for electrostatic charge image development according to any one of (((1))) to (((4))),
wherein silica particles that are not detached from the green toner particles account for 1% by mass or more and 5% by mass or less of the silica particles externally added to the green toner particles when the green toner for electrostatic charge image development is dispersed in water containing a surfactant and sonicated at a power of 40 W and a frequency of 20 kHz for 10 minutes.

(((6))) The green toner for electrostatic charge image development according to any one of (((1))) to (((5))),
wherein the azomethine fluorescent pigment is C.I. Pigment Yellow 101.

(((7))) The green toner for electrostatic charge image development according to any one of (((1))) to (((6))),
wherein the non-fluorescent pigment is at least one selected from the group consisting of C.I. Pigment Green 7, C.I. Pigment Green 36, C.I. Pigment Green 58, C.I. Pigment Green 59, and C.I. Pigment Blue 76.

(((8))) An electrostatic charge image developer comprising the green toner for electrostatic charge image development according to any one of (((1))) to (((7))).

(((9))) A toner cartridge that accommodates the green toner for electrostatic charge image development according to any one of (((1))) to (((7))), the toner cartridge being detachably attached to an image forming apparatus.

(((10))) A process cartridge comprising:
developing means that contains the electrostatic charge image developer according to (((8))) and develops an electrostatic charge image formed on a surface of an image holding member into a toner image with the electrostatic charge image developer, the process cartridge being detachably attached to an image forming apparatus.

(((11))) An image forming apparatus comprising:
an image holding member;
charging means that charges a surface of the image holding member;
electrostatic charge image forming means that forms an electrostatic charge image on the charged surface of the image holding member;
developing means that contains the electrostatic charge image developer according to (((8))) and develops the electrostatic charge image formed on the surface of the image holding member into a toner image with the electrostatic charge image developer;
transfer means that transfers the toner image formed on the surface of the image holding member onto a surface of a recording medium; and
fixing means that fixes the toner image transferred on the surface of the recording medium.

(((12))) An image forming method comprising:
charging a surface of an image holding member;
forming an electrostatic charge image on the charged surface of the image holding member;
developing the electrostatic charge image formed on the surface of the image holding member into a toner image with the electrostatic charge image developer according to (((8)));
transferring the toner image formed on the surface of the image holding member onto a surface of a recording medium; and
fixing the toner image transferred on the surface of the recording medium.

(((13))) An image forming apparatus comprising:
first to sixth electrophotographic image forming units that form pink, yellow, magenta, cyan, black, and green images, respectively,
wherein the image forming unit that forms the green image contains the electrostatic charge image developer according to (((8))).

(((14))) An image forming method comprising:
first to sixth electrophotographic image forming steps of forming pink, yellow, magenta, cyan, black, and green images, respectively,
wherein the electrostatic charge image developer according to (((8))) is used for forming the green image.

What is claimed is:

1. A green toner for electrostatic charge image development, comprising:
green toner particles containing a binder resin, an azomethine fluorescent pigment having an emission peak in a wavelength region of 500 nm or more and 550 nm or less in an emission spectrum, and a non-fluorescent pigment having a reflection peak in a wavelength region of 480 nm or more and 540 nm or less in a reflection spectrum, wherein a mass proportion of the azomethine fluorescent pigment in the green toner particles is 3% by mass or more and 20% by mass or less; and
silica particles externally added to the green toner particles,
wherein the silica particles have an average primary particle size of 50 nm or more and 350 nm or less.

2. The green toner for electrostatic charge image development according to claim 1,
wherein a mass proportion of the azomethine fluorescent pigment in a total of a content of the azomethine fluorescent pigment and a content of the non-fluorescent pigment is 30% by mass or more and 90% by mass or less.

3. The green toner for electrostatic charge image development according to claim 1,
wherein the silica particles are contained in an amount of 0.5 parts by mass or more and 5 parts by mass or less with respect to 100 parts by mass of the green toner particles.

4. The green toner for electrostatic charge image development according to claim 1,
wherein silica particles detached from the green toner particles account for 10% by mass or more and 30% by mass or less of the silica particles externally added to the green toner particles when the green toner for electrostatic charge image development is dispersed in water containing a surfactant.

5. The green toner for electrostatic charge image development according to claim 1,
wherein silica particles that are not detached from the green toner particles account for 1% by mass or more and 5% by mass or less of the silica particles externally added to the green toner particles when the green toner for electrostatic charge image development is dispersed in water containing a surfactant and sonicated at a power of 40 W and a frequency of 20 kHz for 10 minutes.

6. The green toner for electrostatic charge image development according to claim 1,
wherein the azomethine fluorescent pigment is C.I. Pigment Yellow 101.

7. The green toner for electrostatic charge image development according to claim 1,
wherein the non-fluorescent pigment is at least one selected from the group consisting of C.I. Pigment Green 7, C.I. Pigment Green 36, C.I. Pigment Green 58, C.I. Pigment Green 59, and C.I. Pigment Blue 76.

8. An electrostatic charge image developer comprising the green toner for electrostatic charge image development according to claim 1.

9. An electrostatic charge image developer comprising the green toner for electrostatic charge image development according to claim 2.

10. An electrostatic charge image developer comprising the green toner for electrostatic charge image development according to claim 3.

11. An electrostatic charge image developer comprising the green toner for electrostatic charge image development according to claim 4.

12. An electrostatic charge image developer comprising the green toner for electrostatic charge image development according to claim 5.

13. An electrostatic charge image developer comprising the green toner for electrostatic charge image development according to claim 6.

14. An electrostatic charge image developer comprising the green toner for electrostatic charge image development according to claim 7.

15. A toner cartridge that accommodates the green toner for electrostatic charge image development according to claim 1, the toner cartridge being detachably attached to an image forming apparatus.

16. A process cartridge comprising:
a developing unit that contains the electrostatic charge image developer according to claim 8 and develops an electrostatic charge image formed on a surface of an image holding member into a toner image with the electrostatic charge image developer, the process cartridge being detachably attached to an image forming apparatus.

17. An image forming apparatus comprising:
an image holding member;
a charging unit that charges a surface of the image holding member;
an electrostatic charge image forming unit that forms an electrostatic charge image on the charged surface of the image holding member;
a developing unit that contains the electrostatic charge image developer according to claim 8 and develops the electrostatic charge image formed on the surface of the image holding member into a toner image with the electrostatic charge image developer;
a transfer unit that transfers the toner image formed on the surface of the image holding member onto a surface of a recording medium; and
a fixing unit that fixes the toner image transferred on the surface of the recording medium.

18. An image forming method comprising:
charging a surface of an image holding member;
forming an electrostatic charge image on the charged surface of the image holding member;
developing the electrostatic charge image formed on the surface of the image holding member into a toner image with the electrostatic charge image developer according to claim 8;
transferring the toner image formed on the surface of the image holding member onto a surface of a recording medium; and
fixing the toner image transferred on the surface of the recording medium.

19. An image forming apparatus comprising:
first to sixth electrophotographic image forming units that form pink, yellow, magenta, cyan, black, and green images, respectively,
wherein the image forming unit that forms the green image contains the electrostatic charge image developer according to claim 8.

20. An image forming method comprising:
first to sixth electrophotographic image forming steps of forming pink, yellow, magenta, cyan, black, and green images, respectively,
wherein the electrostatic charge image developer according to claim 8 is used for forming the green image.
